(19) United States
(12) Patent Application Publication
(10) Pub. No.: US 2020/0094665 A1
(43) Pub. Date: Mar. 26, 2020

(54) FULL-AUTOMATIC CAR SHADE-SHED

(71) Applicant: Jianqing JIANG, Wenzhou (CN)

(72) Inventor: Jianqing JIANG, Wenzhou (CN)

(21) Appl. No.: 16/699,172

(22) Filed: Nov. 29, 2019

Related U.S. Application Data
(63) Continuation of application No. PCT/CN2017/105243, filed on Oct. 3, 2017.

(30) Foreign Application Priority Data
Jun. 1, 2017 (CN) 201710403072.4

(51) Int. Cl. B60J 11/02; F16H 1/16; B60J 11/04; H02S 40/38; H02S 10/40

(52) U.S. Cl. CPC B60J 11/02; F16H 1/16; H02S 10/40; H02S 40/38; B60J 11/04

(57) ABSTRACT

A full-automatic car shade-shed, including: a base, an electric control device, a shade-shed wrapping, a seat, a shade-shed leg and a linkage device. The linkage device is arranged in a middle of a space below the base. The linkage device includes a worm gearbox with coupled gears, a spur rack, a twin-linked upper slider, a symmetric lower slider mechanism, first and second brace rods symmetrically arranged and parallelly rotatable and inclinable and have foldable frames, first and second crossbars symmetrically arranged and a plurality of winding-unwinding devices. The base is connected to the twin-linked upper slider with two roll cylinders, the symmetric lower slider mechanism with two roll cylinders, the first and second brace rods and the first and second crossbars. The shade-shed can be remotely controlled by the electric control device. The ray-proof shade cloth simultaneously unfolds forward, backward and towards two sides in few seconds.

### CROSS-REFERENCE TO RELATED APPLICATIONS

This application is a continuation of International Patent Application No. PCT/CN2017/105243, filed on Oct. 3, 2017, which claims the benefit of priority from Chinese Application No. 201710403072.4, filed on Jun. 1, 2017. The content of the aforementioned applications, including any intervening amendments thereto, are incorporated herein by reference.

### TECHNICAL FIELD

The present application relates to sunshade devices, and more particularly to a ray-proof sunshade used for cars.

### BACKGROUND OF THE INVENTION

In hot weather, cars in open parking are roasted under the scorching sun. The interior of cars, much like a greenhouse, can reach in excess of 70° C., but heat is hardly dispersed. Drivers are required to keep an air conditioner run for more than ten minutes to cool down a hot car interior before driving, which wastes time and energy and increases greenhouse gas emissions. Moreover, people who just get in the hot car have to suffer the hot seat and seat back for a while, even though the temperature inside the car has already dropped. Such common and unpleasant experience without any solution requires new approaches to change the situation. Some inventions, such as car sunshades or parasols, show an attempt to solve the pain point. Unfortunately, few inventions succeed in commercial practice so far. Several reasons are as follows. Some car sunshades or parasols need to be manually installed and opened for use when parking, and manually removed before driving, and these operations are time-consuming and laborious, so that it is painful for people to operate twice for installing and unloading under the burning sun for a long time. Some automatic car sunshades or parasols can be remotely controlled to be automatically opened for use when parking and automatically folded before driving, however, the folded sunshade or parasol on the car roof still needs to be manually removed, which is a time-consuming and laborious operation and a suffering to do such trying operation under the scorching sun for a long time. Some automatic car parasols can be automatically opened forward and backward, but fail to stretch towards two sides, so the side windows of cars are exposed to the sun, having poor thermal insulating capability.

### SUMMARY OF THE INVENTION

The present invention aims to provide a full-automatic car shade-shed, which has a compact, reasonable and stable structure, a responsive and reliable operation and an anti-theft function. The car driving is not affected by the full-automatic car shade-shed firmly installed on the car roof. The full-automatic car shade-shed can be automatically unfolded or folded, which is easy to use.

The technical solution of this invention will be described as follows.

A full-automatic car shade-shed, comprising:

a base;

an electric control device;

a shade-shed wrapping;

a seat;

a shade-shed leg; and

a linkage device;

wherein the linkage device is provided in a middle of a space below the base, and comprises a worm gearbox with coupled gears, a plurality of spur racks, a twin-linked upper slider, a symmetric lower slider mechanism, two first brace rods, two second brace rods, two first crossbars, two second crossbars and a plurality of winding-unwinding devices; wherein the two first brace rods and the two second brace rods each are parallelly rotatable and inclinable and have foldable frames, each first brace rod and each second brace rod are symmetrically arranged; each first crossbar and each second crossbar are symmetrically arranged;

the base comprises two first fixed supports which are symmetrically arranged at opposite sides of the base, two second fixed supports which are symmetrically arranged at opposite sides of the base, a plurality of bearings, the electrical control device, the twin-linked upper slider, the symmetric lower slider mechanism; two first bearing raceways which are symmetrically provided at opposite sides of a top of the base; two first groove slides are symmetrically provided at opposite outsides of an upper portion of the twin-linked upper slider; the two first bearing raceways are respectively inserted in the two first groove slides;

the symmetric lower slider mechanism comprises a first lower slider and a second lower slider arranged at opposite sides, a first sliding support and a second sliding support arranged at opposite sides, two lower roller frames at front and rear sides, two spur racks arranged at opposite sides and two winding-unwinding devices arranged at opposite sides;

the twin-linked upper slider comprises an upper roller bracket, an upper roller frame, the shade-shed wrapping, a micro switch contact block, two spur racks arranged at opposite sides and two winding-unwinding devices;

each winding-unwinding device comprises a first winding-unwinding mechanism at a front end of the winding-unwinding device, a second winding-unwinding mechanism at a rear end of the winding-unwinding device, a roll cylinder and a ray-proof shade cloth;

one of the two first brace rods is arranged between the twin-linked upper slider and one of the two second crossbars, and one of the two second brace rods is arranged between the twin-linked upper slider and one of the two first crossbars, thereby forming two surfaces of an upper layer of the car shade-shed, and the two surfaces of the upper layer are symmetrically arranged at front and rear sides of the car shade-shed; the other second brace rod is arranged between the first lower slider and the other first crossbar, and the other first brace rod is arranged between the second lower slider and the other second crossbar, thereby forming two surfaces of a lower layer of the car shade-shed, and the two surfaces of the lower layer are symmetrically arranged at the front and rear sides of the car shade-shed; one end of the ray-proof shade cloth is wound on the roll cylinder, and the other end of the ray-proof shade cloth is connected to the first crossbar or the second crossbar;

four shade-shed legs are arranged at four corners below the seat and are configured to connect the car; two inward facing concave rails are provided at an upper portion of the car shade-shed, and two convex rails are provided at opposite sides of a bottom of the base; the two convex rails of the base are respectively inserted in the two inward facing concave rails;

the worm gearbox with coupled gears is arranged in the base, and first and second spur gears are symmetrically arranged at ends of two output ends of the worm gearbox; the first spur gear meshes with one of the two spur racks of the twin-linked upper slider and a spur rack of the first lower slider, and the second spur gear meshes with the other spur rack of the twin-linked upper slider and a spur rack of the second lower slider, forming a twist transmission by meshing the two sets of two spur racks and the first and second spur gears; two ray-proof shade cloths of the twin-linked upper slider and two ray-proof shade cloths of the symmetric lower slider mechanism stretch towards opposite sides to form four surfaces at the upper and lower layers of shade-shed, thereby presenting an unfolded state of the car shade-shed;

a first brace rod and a second brace rod are provided at each of two sides of the base; the first brace rod and the second brace rod each comprise first and second rear fixed hinges, first and second rear movable hinges, first and second rear brace rods respectively arranged up and down, a first inclinable device which is parallelly rotatable, a second inclinable device which is parallelly rotatable, an intermediate sliding rod, first and second front brace rods respectively arranged up and down, first and second front movable hinges, first and second front fixed hinges and a plurality of bearing; the first and second rear brace rods have arc-shaped tops and bottoms, and are respectively provided with a through hole at a middle section, and are arranged crosswise; through holes of the first and second rear brace rods are connected via hollow rivets; the first and second rear brace rods have flat surfaces on two sides, and rear ends of the flat surfaces each are symmetrically provided with six third screw holes; the six third screw holes are connected to the first and second rear movable hinges arranged down and up, respectively, and the first and second rear movable hinges arranged up and down are respectively connected to the first and second rear fixed hinges arranged up and down; front ends of the flat surfaces each are symmetrically provided with two circular holes;

the first and second brace rods located at the same side are respectively arranged in the upper and lower layers; the upper and lower layers each are provided with first and second brace rods; for the upper layer of the car shade-shed, one end of the first rear brace rod is connected to a first fixed support of the base by the first rear fixed hinge, and one end of the second rear brace rod is connected to six second screw holes of an upper roller bracket of the twin-linked upper slider, and the other end of the first rear brace rod is connected to the first inclinable device, and the other end of the second rear brace rod is connected to the second inclinable device;

for each of the first and second brace rods at the lower layer of the car shade-shed, one end of the first rear brace rod is connected to each of the second fixed supports of the base, and one end of the second rear brace rod is connected to each of the first and second sliding supports of the symmetric lower slider mechanism, and the other end of the first rear brace rod is connected to the first inclinable device, and the other end of the second rear brace rod is connected to the second inclinable device;

the first inclinable device comprises a first hinge joint, a first short ball joint, a first long ball joint and a cylindrical ball head made of stainless steel; a circular boss is provided at a top of a rear section of the first hinge joint, and a screw hole is provided at a center of the boss; a circular arc groove is provided at an inside of the rear section of the first hinge joint, and a concave through hole which has two flat surfaces at two sides and two circular surfaces at upper and lower sides is provided at a center of the circular arc groove and connects a circular hole to communicate with an outside; a rear port of the cylindrical ball head is embedded in the concave through hole at a center of an inside of the first hinge joint; a rear section of the cylindrical ball head has two flat surfaces at opposite sides and two circular surfaces at upper and lower sides, which is similar to that of the concave through hole of the first hinge joint; the cylindrical ball head is provided with a screw hole at a center of a rear port, a cylinder at a middle section and a sphere at a front section;

a lower portion of a front section of the first hinge joint is provided with a rectangular boss with two flat surfaces at opposite sides and two circular surfaces at upper and lower sides; two circular holes are symmetrically provided on the flat surfaces; a top of the first short ball joint is provided with two circular holes communicated with a bottom surface; a first hemisphere that is concave upwards is provided beside the bottom surface; a flat surface is provided at a rear portion of the first hemisphere and a rail that is inclined downwards is provided at a front portion of the first hemisphere; a top surface of a rear section of the first long ball joint is provided with two circular holes communicated with a bottom, and a second hemisphere that is concave downwards is provided beside the top surface of the rear section of the first long ball joint; a flat surface is provided at a rear portion of the second hemisphere and a rail that is inclined downwards is provided at a front portion of the second hemisphere;

a lower portion of a front section of the first long ball joint is provided with a rectangular boss with two circular surfaces at upper and lower sides and two flat surfaces at opposite sides; two circular holes are symmetrically arranged on the flat surfaces of the rectangular boss of the first long ball joint;

the first short ball joint is provided above the first long ball joint to form a spherical space and a slide around the spherical space; a rear portion of the slide has upper and lower planes and a front portion of the slide is rotational and inclined downwards; the sphere at the front section of the cylindrical ball head and the cylinder at the middle section of the cylindrical ball head are arranged in the spherical space and the slide around the spherical space; the rear port of the cylindrical ball head is connected to the first hinge joint via stainless steel screws; the cylinder at the middle section of the cylindrical ball and the sphere at the front section of the cylindrical ball are connected to the first short ball joint and the first long ball joint;

the second inclinable device has the same components as the first inclinable device; the second short ball joint is provided below the second long ball joint to form a spherical space and a slide around the spherical space; a rear portion of the slide has upper and lower planes and a front portion of the slide is rotational and inclined downwards; the sphere at the front section of the cylindrical ball head and the cylinder at the middle section of the cylindrical ball head are arranged in the spherical space and the slide around the spherical space; the rear port of the cylindrical ball head is connected to the second hinge joint via stainless steel screws; the cylinder at the middle section of the cylindrical ball and the sphere at the front section of the cylindrical ball are connected to the second short ball joint and the second long ball joint; the circular bosses at tops of the first and second inclinable devices each are connected to the intermediate sliding rod;

the first and second front brace rods have arc-shaped tops and bottoms, and two through holes which are concentric are respectively provided on the first and second front brace rods, and each through hole is between a top and a bottom; the first and second front brace rods are arranged crosswise and respectively located down and up; the two through holes are connected via hollow rivets; rear ends of the first and second front brace rods are respectively connected to the first inclinable device and the second inclinable device; the first and second front brace rods have flat surfaces on two sides, and rear ends of the flat surfaces each are symmetrically provided with two circular holes; the front ends of the flat surfaces each are symmetrically provided with four screw holes which are connected to the first and second front movable hinges, respectively; the first and second front movable hinges arranged down and up are respectively connected to the first and second front fixed hinges arranged down and up; the first front fixed hinge arranged down is connected to four bearings, and two fourth bearing raceways are formed on the four bearings; each fourth bearing raceway is slidably connected to the first and second crossbars, respectively.

In some embodiments, the base is made of extruded profiles; first bearing raceways are symmetrically arranged at opposite sides of the top of the base; a first concave channel is provided at a middle of the top of the base; second bearing raceways are symmetrically arranged at opposite outsides of an upper portion of the base; third bearing raceways are symmetrically arranged at opposite outsides of a middle portion of the base; a shoulder screw with slotted raised head, a rolling bearing, a washer and the base are connected to form a raceway unit, and a plurality of raceway units connected to the base are uniformly arranged in a longitudinal line, thereby forming the first bearing raceways, the second bearing raceways and the third bearing raceways which are arranged in a longitudinal direction; upper and lower second groove slides are respectively arranged at a top and a bottom of the first lower slider, and upper and lower third groove slides are respectively arranged at a top and a bottom of the second lower slider;

middle and lower portions of the twin-linked upper slider are arranged in the first concave channel at the middle of the top of the base; one second bearing raceway and one third bearing raceway are respectively inserted the upper and lower second groove slides; the other second bearing raceway and the other third bearing raceway are respectively inserted the upper and lower third groove slides;

the electrical control device comprises a solar panel, a solar base handle cover, a rechargeable battery, a solar charging socket, a remote control receiver, a remote controller, a starting micro switch, a stop micro switch, an electrical panel and a special vehicle-mounted fan; the electric panel is provided with a battery indicator, a main switch of the shade-shed and a socket for charging and discharging; the special vehicle-mounted fan comprises an electric fan, a fan base, a base cushion, a metal hose, a sucker, a switch and a wire plug;

the first fixed supports are symmetrically provided at opposite sides of a front top of the base, respectively; the second fixed supports are symmetrically provided at opposite outsides of a rear lower portion of the base; the starting micro switch and the stop micro switch are respectively arranged at a front section and a rear section of the first concave channel at the middle of the top of the base; a space is provided at an inside of a lower portion of the base, and the rechargeable battery and the remote control receiver are arranged at a front portion of the space; inside trapezoidal channels are symmetrically arranged at opposite insides of the first concave channel, respectively, and outer trapezoidal channels are symmetrically arranged at opposite outsides of the first concave channel, respectively; the four trapezoidal channels are symmetrically arranged; the electrical panel is connected to a port of the front portion of the space at the lower portion of the base; the solar base handle cover is connected to a port of a rear top of the base; a middle of a rear section of the bottom of the base is provided with four circular holes vertically spaced; a middle section of the bottom of the base is provided with a rectangular opening which is communicated with the space at the lower portion of the base; a middle top of the space at the lower portion of the base is provided with two circular holes symmetrically arranged; the worm gearbox passes the rectangular opening to enter the space of the base and then the worm gearbox is arranged near a center of the space of the base; the first and second spur gears symmetrically arranged at the two output ends of opposite sides of the worm gearbox are rotatably embedded in the two circular holes symmetrically arranged at the middle top of the space of the base.

In some embodiments, a top of the twin-linked upper slider is a rectangular plane; concave channels with right angles are arranged at opposite sides of the top of the twin-linked upper slider; two rectangular convex planes with right angles are symmetrically provided at opposite insides below the top of the twin-linked upper slider; the first groove slides are symmetrically arranged at opposite outsides of the upper portion of the twin-linked upper slider; first dovetail rails are symmetrically arranged at opposite outsides of a lower portion of the twin-linked upper slider, and are inserted with two spur racks; a second concave channel is provided at a bottom of the twin-linked upper slider; a micro switch contact block is provided at a top of a rear section of the second concave channel, and is connected to the starting micro switch on a rear section of the base; the first groove slides are respectively inserted inside the first bearing raceways; the two spur racks of the twin-linked upper slider sliding fit with the inside trapezoidal channels, respectively; the two spur racks of the twin-linked upper slider respectively intersect the two circular holes symmetrically arranged at a middle of the base; the upper roller frame is arranged at a front end of a top of the twin-linked upper slider; the upper roller frame has a flat top, and two circular holes symmetrically arranged and six first screw holes are provided on the flat top of the upper roller frame; an upper portion of the upper roller frame is provided with two circles that are twin-linked; a lower portion of the upper roller frame is provided with two blocks, and the two blocks are connected to bottoms of the two circles and are respectively provided with two protrusions with right angles; two countersink circular holes are provided at a center of a bottom of the two circles and communicated with the two blocks; the upper roller bracket is provided at a rear end of the top of the twin-linked upper slider; tops of the upper roller bracket and the upper roller frame have the same structure; six second screw holes are provided at each of opposite outsides of the upper roller bracket; lower portions and bottoms of the upper roller bracket and the upper roller frame have the same structure; the shade-shed wrapping comprises a cloth, a shade-shed cover plate, two elastic sheets, two wool tops, four nylon Velcro tapes with rough surfaces and a nylon Velcro tape with a barbed surface; two winding-unwinding devices are arranged between the upper roller bracket and the upper roller frame; each winding-unwinding device comprises the first winding-unwinding mechanism and the second winding-unwinding mechanism; the roll cylinder is arranged between the first and second winding-unwinding mechanisms; the ray-proof shade cloth is wound on the roll cylinder; the shade-shed cover plate of the shade-shed wrapping is arranged above top surfaces of the upper roller bracket and the upper roller frame.

In some embodiments, the first lower slider and the second lower slider are made of extruded profiles; a first arc channel is provided at an outside of the first lower slider near the roll cylinder, and a first convex track is provided on the first arc channel; two lower roller frames are respectively connected to front and rear ends of the first arc channel, and respectively provided with first and second winding-unwinding mechanisms; a roll cylinder is arranged between the first and second winding-unwinding mechanisms, and the ray-proof shade cloth is wound on the roll cylinder; a second dovetail rail is provided at an outside of the first lower slider away from the roll cylinder, and a spur rack is inserted in the second dovetail rail; a first concave rail is provided at a side of the bottom of the first lower slider near the roll cylinder; a second convex track is provided at a top of the first sliding support; the first sliding support is inserted in a rear port of the first concave rail; the first lower slider and the second lower slider are same in the structure; the spur rack of the first lower slider sliding fits with one outer trapezoidal channel of the base and intersects one circular hole at the middle of the base; the spur rack of the second lower slider sliding fits with the other outer trapezoidal channel and intersects the other circular hole at the middle of the base.

In some embodiments, two first crossbars and two second crossbars are provided herein; the first crossbar and the second crossbar have the same structure and are arranged symmetrically; a beam and a third fixed support is provided on the first and second crossbars, respectively; the beam is made of extruded profiles, and an outside of the beam is flat; upper and lower concave rails are symmetrically arranged at an inner side of the beam; upper and lower convex rails are symmetrically arranged at an outside of the third fixed support; the upper and lower convex rails are respectively embedded in the upper and lower concave rails; an inner side of the third fixed support is provided with a plane, and two screw holes are provided on the plane to connect the second front hinge of the second front brace rod; the upper and lower concave rails are inserted in the two fourth bearing raceways; an outside of the beam is connected to the ray-proof shade cloth via double-sided tapes and pulling rivets.

In some embodiments, the first winding-unwinding mechanism comprises an adjusting baffle, a spring sleeve, a sleeve cover plate and a scrolling clockwork spring; a rear section of the adjusting baffle is a cylinder, and a middle section of the adjusting baffle is a slightly smaller cylinder, and a first groove is provided at a middle of the slightly smaller cylinder; a front section of the adjusting baffle is a round shaft connected with an opening mandrel; a rear section of the spring sleeve is a small roll, and a front section of the spring sleeve is a large roll; a second groove is provided at a middle of the large roll, and two cross openings and four small rectangular openings are provided on a circumference of the second groove; four semicircular grooves are provided at an inside of a front port of the spring sleeve; a rear section of the sleeve cover plate is circular, and a first round hole is provided at a center of a rear port of the sleeve cover plate; the four semicircular bosses and four small rectangular bosses are provided on a circumference of the circle at a rear section of the sleeve cover plate, and the four small rectangular bosses and the four semicircular bosses are staggered; a square body is provided at a front section of the sleeve cover plate, and a second round hole is provided at a center of a port of the square body, and the second round hole is communicated with the first round hole at the rear port of the sleeve cover plate; the adjusting baffle is connected to the spring sleeve; an inner end of the scrolling clockwork spring is connected to the opening mandrel at the front section of the adjusting baffle; an outer end of the scrolling clockwork spring is connected to the two cross openings of the spring sleeve; the sleeve cover plate connects to the adjusting baffle and the spring sleeve; the second winding-unwinding mechanism and the first winding-unwinding mechanism have the same structure; the roll cylinder is arranged between the square body at the front section of sleeve cover plate of the first winding-unwinding mechanism and the square body at the front section of sleeve cover plate of the second winding-unwinding mechanism; the roll cylinder is wrapped with the ray-proof shade cloth; the second winding-unwinding mechanism is provided with a back-scrolling clockwork spring.

In some embodiments, the seat comprises a shade-shed base, an anti-theft lock for locking the base and four nylon Velcro tapes with barbed surfaces; the shade-shed base is made of extruded profiles; two inward facing concave rails are symmetrically and longitudinally arranged at opposite sides of an upper portion of the shade-shed base; a longitudinal channel is formed between the two inward facing concave rails; opposite sides of a middle of the shade-shed base are flat; two quad-side-encircled channels are symmetrically arranged at opposite sides of a lower portion of the shade-shed base, and the two quad-side-encircled channels are separated and longitudinally arranged; the two quad-side-encircled channels have flat tops, and opposite sides of the two quad-side-encircled channels are arc surfaces which are connected to the flat tops; two longitudinal concave tracks are symmetrically arranged at opposite sides of bottoms of the two quad-side-encircled channels, and a space passage is formed in a middle of each of the two quad-side-encircled channels; a longitudinal concave channel is provided between the bottoms of the two quad-side-encircled channels; a longitudinal boss with a flat surface is arranged at a top-center of the longitudinal channel, and a rear end of the longitudinal boss is provided with four screw holes, and a center of the four screw holes is provided with a circular hole communicated with a top of the shade-shed base; two nylon Velcro tapes with barbed surfaces are arranged at opposite sides of a front section of the shade-shed base; two nylon Velcro tapes with barbed surfaces are arranged at opposite sides of a rear section of the shade-shed base; the four screw holes at the rear end of the longitudinal boss and the circular hole at the center of the four screw holes are connected to the anti-theft lock; the convex rails are provided at the opposite sides of the bottom of the base, and the convex rails are respectively inserted in the two inward facing concave rails;

four shade-shed legs are respectively connected to two front ports and two rear ports of the two quad-side-encircled channels at opposite sides of the seat; each of the four shade-shed legs is provided with a stainless steel tensioning bar and a leg base; the leg base is provided with a cushion, and four cushions are respectively attached to four places of the car roof; each stainless steel tensioning bar is connected to a hook plate which is made of metal combined with soft rubber on an inner side and is configured to hook four corners of the car; the hook plate is covered with a leather sleeve attached at four edges of the car.

In some embodiments, the worm gearbox with coupled gears comprises a lower body, a box cover, two bearings, four copper sleeves, two turbine spur gears and a worm motor; the lower body comprises encircled-four-walls and a lower body bottom connected to the encircled-four-walls; two first arc curved surfaces are symmetrically arranged at a bottom of the encircled-four-walls, and the two first arc curved surfaces are connected with each other and communicated at middle sections of the two first arc curved surfaces; the two first arc curved surfaces each are provided with a circular boss; a central circular hole is provided on the circular boss; two central circular holes are respectively inserted in two copper sleeves; each copper sleeve tightly fits with each central circular hole; four first round holes are provided at four corners of a top of the encircled-four-walls and are communicated with the bottom of the encircled-four-walls; a round groove is provided at a center of a front inside of the encircled-four-walls; the round groove is inserted in a front inside copper sleeve, and the round groove tightly fits with the front inside copper sleeve; a rear central round hole is provided at a center of a rear inside of the encircled-four-walls, and the rear central round hole is inserted in a rear inner copper sleeve, and the rear central round hole tightly fits with the rear inner copper sleeve; the front inside copper sleeve and the rear inner copper sleeve are concentric;

four second round holes are provided at four corners of a rear outer port of the lower body; a rear outer central round hole is provided at a center of the four second round holes, and the rear outer central round hole is communicated with the rear central round hole and is concentric to the rear central round hole; a worm head of the worm motor enters the front inside copper sleeve from the rear outer central round hole; a middle section of a worm is arranged in the rear inner copper sleeve; worm tooth on the worm is arranged at a center of the two first arc curved surfaces; the worm motor is connected to the four second round holes via stainless steel screws;

a bottom of the box cover is provided with two second arc curved surfaces which are connected to each other and communicated with each other and are symmetrically arranged; two arc bosses are respectively provided on the two second arc curved surfaces; two circular concave surfaces are arranged between the two arc bosses; two bearings are inserted in the two circular concave surfaces; a center of the two circular concave surfaces is provided with two circular holes which are symmetric and communicated with a top of the box cover; four third round holes are provided on four corners of the top of the box cover, and the four third round holes and the four second round holes are concentric and communicated; each turbine spur gear comprises two tailor-made shafts, a tailor-made turbine and two tailor-made spur gears; each tailor-made shaft is a long cylinder; a lower section of the tailor-made shaft is cylindrical, and a middle section of the tailor-made shaft has two circles of tooth marks; an upper section of the tailor-made shaft is provided with a semi-circular cylinder; an upper section of the tailor-made turbine is provided with a combination of large and small cylinders, and a lower section of the tailor-made turbine is provided with a turbine; a bottom of the turbine is provided with a small round boss; a round through hole is provided between a top center and a bottom center;

the two tailor-made spur gears are dual output ends; a lower section of each tailor-made spur gear is cylindrical, and an upper section of the tailor-made spur gear is provided with a spur gear; a top center of the spur gear is provided with a semicircular hole that is communicated with a bottom of the spur gear; the tailor-made spur gear is embedded in the semi-circular cylinder of the tailor-made shaft; the semi-circular cylinder tightly fits with the tailor-made spur gear; the two tailor-made shafts are respectively inserted in two copper sleeves in two central circular holes of the lower body; two turbines are symmetrically arranged at opposite sides and mesh with the worm tooth of the worm at a middle of the lower body; the two tailor-made spur gears are inserted in the two bearings on the box cover and protrude out of the top of the box cover through two round holes; the front inside copper sleeve and the rear inner copper sleeve are connected to the worm on the worm motor; two copper sleeves at a lower side of the lower body are connected to the two turbine spur gears; two turbine spur gears are connected to the box cover; the lower body and the box cover are connected via stainless steel screws; a rear port of the lower body is connected to the worm motor via stainless steel screws.

In some embodiments, the electrical control device comprises a solar panel, a solar base handle cover, a rechargeable battery, a solar charging socket, a remote control receiver, a remote controller, a starting micro switch, a stop micro switch, an electrical panel and a special vehicle-mounted fan; the electric panel is provided with a battery indicator, a main switch of the shade-shed and a socket for charging and discharging; four round holes are provided at four corners of on a top plane of the solar base handle cover; a round hole connected to a square hole is arranged a top of the solar base handle cover; a wire groove from the top to the bottom is arranged below the square hole and located at a front side of an upper portion of the solar base handle cover; two rectangular cantilevers with right angles are symmetrically arranged at opposite sides of a middle section of the solar base handle, and the two rectangular cantilevers with right angles protrude from the back to the front; an encircled-five-side boss is arranged at a lower portion of the solar base handle, and the encircled-five-side boss protrudes from the back to the front; a semi-circular groove from the back to the front is arranged on a top plane of the encircled-five-sides boss; a rear end of the semi-circular groove is connected to the wire groove; a horizontal handlebar is provided at a rear port of the encircled-five-sides boss; there are space at upper and lower peripheries of the horizontal handlebar; the shape of the encircled-five-side boss is similar to the shape of the lower space of the base; a top of the solar base handle cover is connected to the solar panel; the two cantilevers symmetrically arranged at a middle portion of the solar base handle cover is connected to opposite rear ends of the top of the base; the encircled-five-side boss is inserted into a lower rear space of the base; a wire plug on the solar panel enters the lower space of the base from top to bottom and along the round hole connected to the square hole and the wire groove to connect to the solar charging socket; the other end of the solar charging socket is connected to the rechargeable battery;

the rechargeable battery is first connected to the main switch of the shade-shed, and then connected to the battery indicator, the socket for charging and discharging, the remote control receiver; the remote control receiver is connected to the starting micro switch, the stop micro switch and the worm motor.

In the present invention, two roll cylinders wrapped with the ray-proof shade cloth are connected to the twin-linked upper slider, and two roll cylinders wrapped with the ray-proof shade cloth are connected to the first and second lower sliders. One end of the ray-proof shade cloth is attached on each roll cylinder, and the other end of the ray-proof shade cloth is connected to the first crossbar or the second crossbar, and the first and second brace rods are configured to connect the first and second crossbars to the twin-linked upper slider, the symmetric lower slider mechanism and the base. Remote operation of a controller makes the motor rotate forward. Two spur gears symmetrically arranged at the worm gearbox rotate to drive four spur racks on the twin-linked upper slider and the symmetric lower slider mechanism to move, so that the ray-proof shade cloth simultaneously unfolds forward, backward and towards two sides from the base in few seconds, providing a sufficiently large covering area to shade the cars. In the case where the unfolded shade-shed is needed, the users hold the controller and press an “open” button of the controller, the worm motor operates forward to make the twin-linked upper slider and the first and second lower sliders slide in an opposite direction. When the micro switch contact block of the twin-linked upper slider slides forward and touches the stop micro switch at the front section of the base, the worm motor stops rotating, at this time, the full-automatic car shade-shed is fully unfolded, and meanwhile the wire plug of the special vehicle-mounted fan is inserted upwards into the socket for charging and discharging on the electrical panel, and the fan operates by pressing a switch to cool down the interior of the car. In the case where the shade-shed is not required, the users hold the controller and press a “close” button of the controller, the worm motor operates backward, the micro switch contact block of the twin-linked upper slider slides backward to touch the starting micro switch at the rear section of the base, the worm motor stops rotating, at this time, the full-automatic car shade-shed is completely folded like a packing case. The full-automatic car shade-shed of this invention has a compact, reasonable and stable structure, a responsive and reliable operation and an anti-theft function. The full-automatic car shade-shed firmly installed on the car roof can be automatically unfolded or folded, which is easy to use.

### BRIEF DESCRIPTION OF THE DRAWINGS

FIG. 1 is a schematic view of an unfolded car shade-shed installed on a car roof of the present invention;

FIG. 2 is a schematic view of a folded car shade-shed installed on a car roof of the present invention;

FIG. 3 is a cross-sectional view of a front end of the full-automatic car shade-shed of the present invention;

FIG. 4 is a cross-sectional view of a rear end of the full-automatic car shade-shed of the present invention;

FIG. 5 is a schematic view of a base of the full-automatic car shade-shed of the present invention;

FIG. 6 schematically shows unfolded first and second brace rods of the full-automatic car shade-shed of the present invention;

FIG. 7 is a schematic view of a twin-linked upper slider of the full-automatic car shade-shed of the present invention;

FIG. 8 is a schematic view showing first and second lower sliders of the full-automatic car shade-shed of the present invention;

FIG. 9 is a schematic view showing a combination of the base, the twin-linked upper slider and the first and second lower sliders of the present invention;

FIG. 10 schematically shows a first brace rod of first and second brace rods symmetrically arranged and parallelly rotatable and inclinable and have foldable frames;

FIG. 11 is a three-view comparison diagram of first and second inclinable devices which are parallelly rotatable;

FIG. 12 is a schematic view of a winding-unwinding device;

FIG. 13 is a schematic view of a worm gearbox with coupled gears;

FIG. 14 is a cross-sectional view of the worm gearbox with coupled gears;

FIG. 15 is a schematic view of a solar base handle cover;

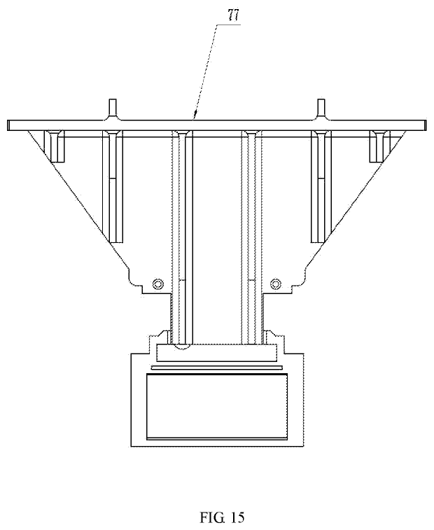

FIG. 16 is a schematic view of first and second crossbars symmetrically arranged; and

FIG. 17 is a schematic view of a seat and a shade-shed leg.

### DETAILED DESCRIPTION OF EMBODIMENTS

The embodiments of this invention will be further described below with reference to the accompanying drawings.

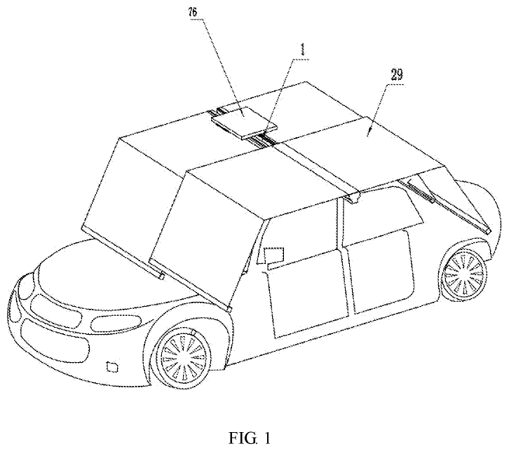

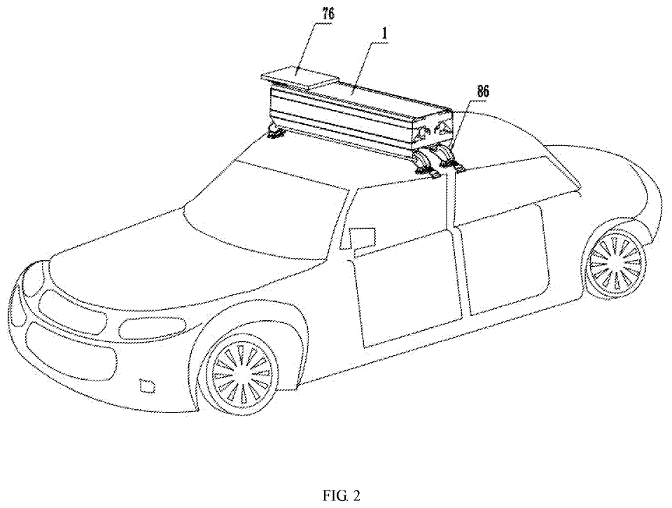

FIG. 1 is a schematic view showing an unfolded state of a full-automatic car shade-shed 1 arranged on a car roof, and FIG. 2 is a schematic view showing a folded state of the full-automatic car shade-shed 1 arranged on the car roof, where the full-automatic car shade-shed 1 mainly includes a base 2, a twin-linked upper slider 11, a first lower slider 30 and a second lower slider 31 that are symmetrically arranged, first and second crossbars 59 symmetrically arranged, a ray-proof shade cloth 29, first and second brace rods 46, a seat 83 and a shade-shed leg 86, where the first and second brace rods are symmetrically arranged and parallelly rotatable and inclinable and have foldable frames.

First, the assemblies of respective components are described as follows.

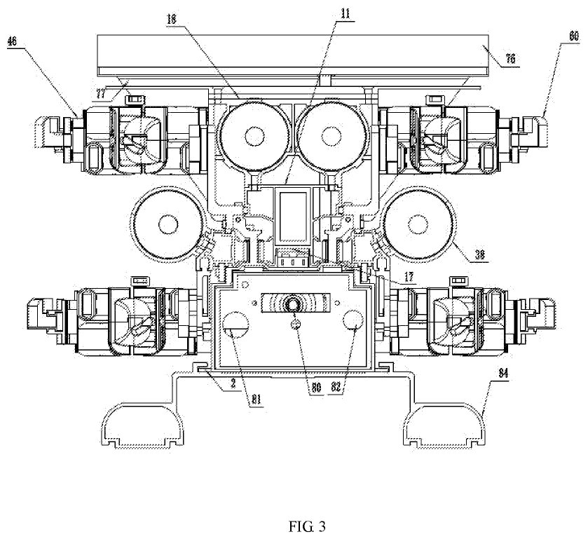

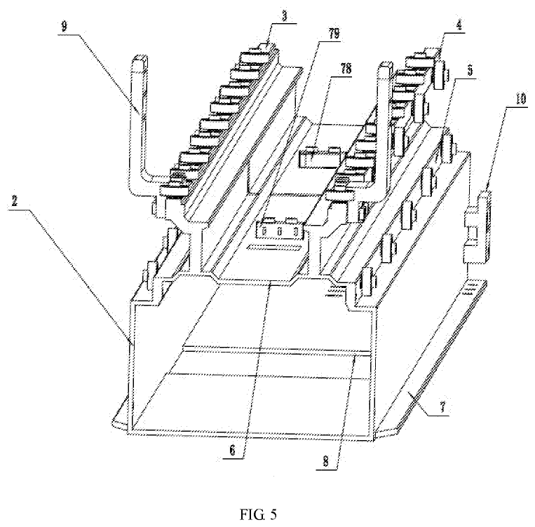

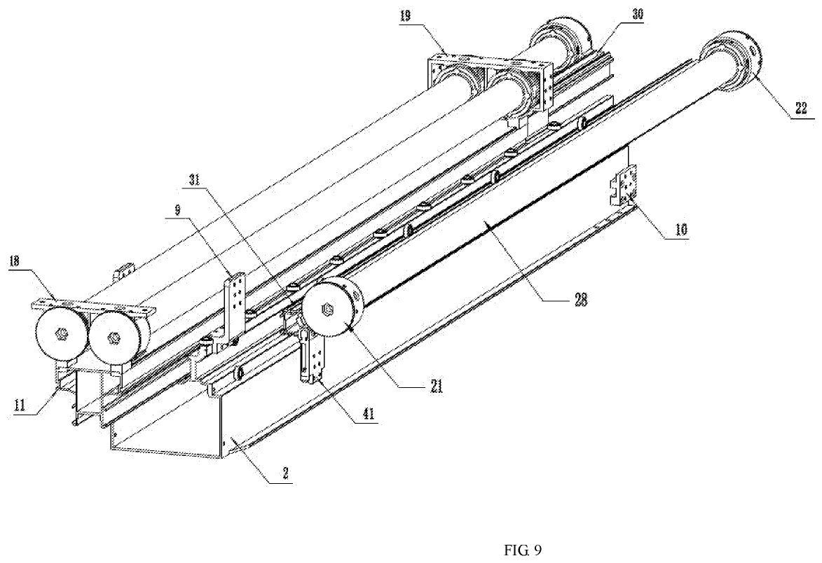

1) The assembly of the base 2: the base 2 is an irregular extruded profile (as shown in FIG. 5). Firstly, a shoulder screw with slotted raised head, a bearing, a washer and the base are connected to form a raceway unit, and a plurality of raceway units connected to the base 2 are uniformly arranged in a longitudinal line, thereby forming first and second first bearing raceways 3 symmetrically arranged on opposite sides of a top of the base, two second bearing raceways 4 symmetrically arranged on opposite outsides of an upper portion of the base and two third bearing raceways 5 symmetrically arranged on opposite outsides of a middle of the base (as shown in FIG. 5). The first and second first bearing raceways 3 are respectively inserted two first groove slides 14 symmetrically arranged on opposite outsides of an upper portion of the twin-linked upper slider 11. Middle and lower portions of the twin-linked upper slider 11 are arranged in a first concave channel 6 in a middle of the top of the base. The two second bearing raceways 4 and the two third bearing raceways 5 are respectively inserted in upper and lower second groove slides 32 of the first lower slider 30 and upper and lower third groove slides 33 of the second lower slider 31, thereby combining the base 2, the twin-linked upper slider 11, the first lower slider 30 and the second lower slider 31 (as shown in FIG. 9). Two first fixed supports 9 are symmetrically arranged at opposite sides of a front top of the base 2. Two second fixed supports 10 are symmetrically arranged at opposite outsides of a rear lower portion of the base 2. A stop micro switch 79 and a starting micro switch 78 are respectively provided at a front part and a rear part of the first concave channel 6, respectively (as shown in FIG. 5). As shown in FIG. 3, a front port of a lower portion of the base 2 is connected to an electrical panel, on which a battery indicator 80, a main switch of the shade-shed and a socket for charging and discharging are provided. A solar base handle cover 77 is provided at a rear end of the top of the base 2, and a solar panel 76 is provided above the solar base handle cover 77. A wire plug of the solar panel 76 is connected to a solar charging socket in a lower space of the base. The solar charging socket is connected to a rechargeable battery, which is connected to the main switch 81 of the shade-shed, the battery indicator 80, the socket for charging and discharging 82 and a remote-control receiver. The remote-control receiver is connected to the starting micro switch 78, the stop micro switch 79 and a worm motor. The rechargeable battery and the remote-control receiver are arranged in a space of a front lower portion of the base.

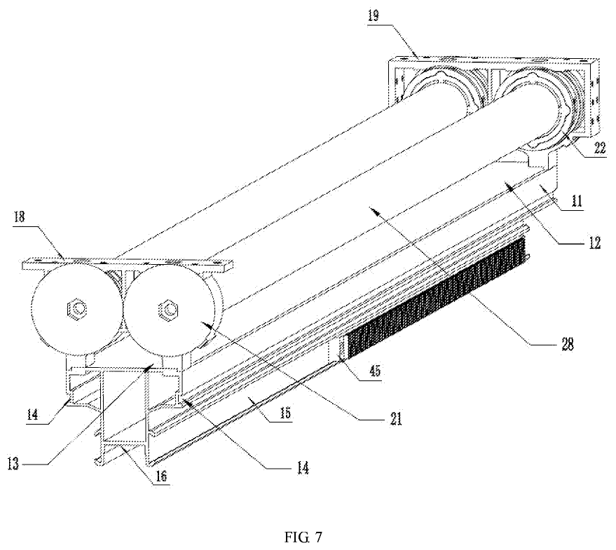

2) The assembly of the twin-linked upper slider 11: the twin-linked upper slider 11 is an irregular extruded profile. An upper roller frame 18 and an upper roller bracket 19 are respectively arranged on a front rectangular plane 13 and a rear rectangular plane 12 of a top of the twin-linked upper slider 11 (as shown in FIG. 7), and are respectively connected to two first winding-unwinding mechanisms 21 and two second winding-unwinding mechanisms 22. A roll cylinder 28 is arranged between each first winding-unwinding mechanism 21 and each second winding-unwinding mechanism 22 (as shown in FIG. 7), and the roll cylinder 28 is wrapped with the ray-proof shade cloth 29. The two first groove slides 14 symmetrically arranged on the two outsides of the upper portion of the twin-linked upper slider are connected to the first and second first bearing raceways 3. Two spur racks 45 are symmetrically provided at two first dovetail rails 15 on opposite outsides of the lower portion of the twin-linked upper slider (as shown in FIG. 7). A micro switch contact block 17 is provided at an upper side of a rear section of a second concave channel 16 at a bottom of the twin-linked upper slider 11 (FIG. 3 shows a detailed location layout), and the micro switch contact block 17 on the twin-linked upper slider 11 is connected to the starting micro switch 78 arranged at a middle of a rear part of the first concave channel 6 on the top of the base.

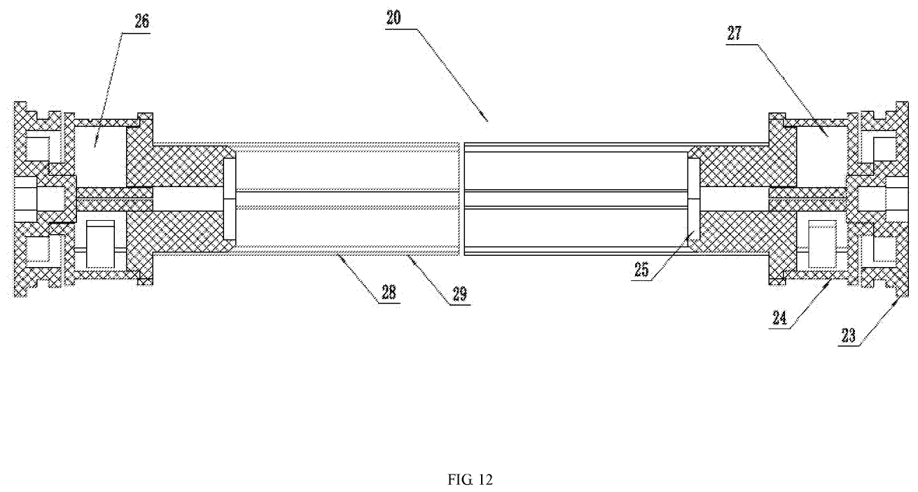

3) The assembly of a winding-unwinding device 20: there are four winding-unwinding devices provided herein. Each winding-unwinding device includes the first winding-unwinding mechanism 21, the second winding-unwinding mechanism 22, the roll cylinder 28 and the ray-proof shade cloth 29. As shown in FIG. 12, the first winding-unwinding mechanism 21 includes an adjusting baffle 23, a spring sleeve 24, a sleeve cover plate 25 and a scrolling clockwork spring 26. The adjusting baffle 23 is connected to the spring sleeve 24. An inner end of the scrolling clockwork spring 26 is connected to an opening mandrel of the adjusting baffle 23, and an outer end of the scrolling clockwork spring 26 is connected to a cross opening of the spring sleeve 24. A central circular hole of the sleeve cover plate 25 is connected to the adjusting baffle 23, and a rear section of the sleeve cover plate 25 is connected to the spring sleeve 24, and a front section of the sleeve cover plate 25 is connected to a port of the roll cylinder 28. The second winding-unwinding mechanism includes an adjusting baffle 23, a spring sleeve 24, a sleeve cover plate 25 and a back-scrolling clockwork spring 27. The adjusting baffle 23 is connected to the spring sleeve 24. An inner end of the back-scrolling clockwork spring 27 is connected to an opening mandrel of the adjusting baffle 23, and an outer end of the back-scrolling clockwork spring 27 is connected to a cross opening of the spring sleeve 24. A central circular hole of the sleeve cover plate 25 is connected to the adjusting baffle 23, and a rear section of the sleeve cover plate 25 is connected to the spring sleeve 24, and a front section of the sleeve cover plate 25 is connected to another port of the roll cylinder 28. An end of the ray-proof shade cloth 29 is adhered to the roll cylinder 28 by double-sided tapes, and the roll cylinder 28 is wrapped with the ray-proof shade cloth 29.

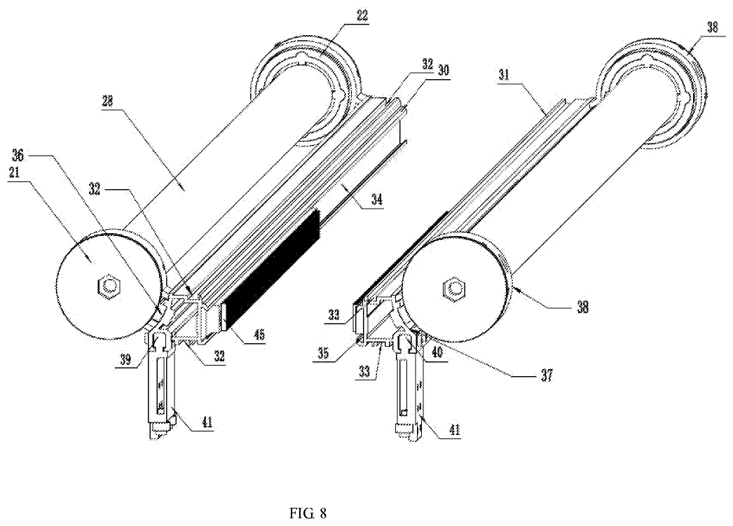

4) The assembly of the first lower slider 30 and the second lower slider 31: as shown in FIG. 8, the first lower slider 30 and the second lower slider 31 are irregular extruded profiles. The upper and lower second groove slides 32 are respectively provided at the top and bottom of the first lower slider. A spur rack 45 is provided at a second dovetail rail 34 at an outside of the first lower slider away from the roll cylinder. Two lower roller frames 38 are respectively provided at front and rear ends of a first arc channel 36 which is arranged at an outside of the first lower slider near the roll cylinder, and respectively connected to a first winding-unwinding mechanism 21 and a second winding-unwinding mechanism 22. A roll cylinder 28 is arranged between the first winding-unwinding mechanism 21 and the second winding-unwinding mechanism 22, and the roll cylinder 28 is wrapped with the ray-proof shade cloth 29. A first sliding support 41 is provided at a rear end of a first concave rail 39 at a side of the bottom of the first lower slider near the roll cylinder. The upper and lower third groove slides 33 are respectively provided at the top and bottom of the second lower slider 31. A spur rack 45 is provided at a third dovetail rail 35 at an outside of the second lower slide away from the roll cylinder. Two lower roller frames 38 are provided at front and rear ends of a second arc channel 37 at an outside of the second lower slider near the roll cylinder, and respectively connected to a first winding-unwinding mechanism 21 and a second winding-unwinding mechanism 22. A roll cylinder 28 is arranged between the first winding-unwinding mechanism 21 and the second winding-unwinding mechanism 22 and the roll cylinder 28 is wrapped with the ray-proof shade cloth 29. A second sliding support 41 is provided at a rear end of a second concave rail 40 at an outside of the second lower slider near the roll cylinder.

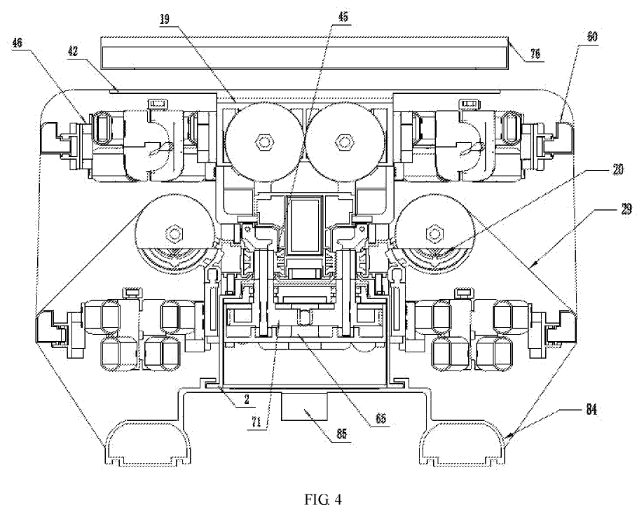

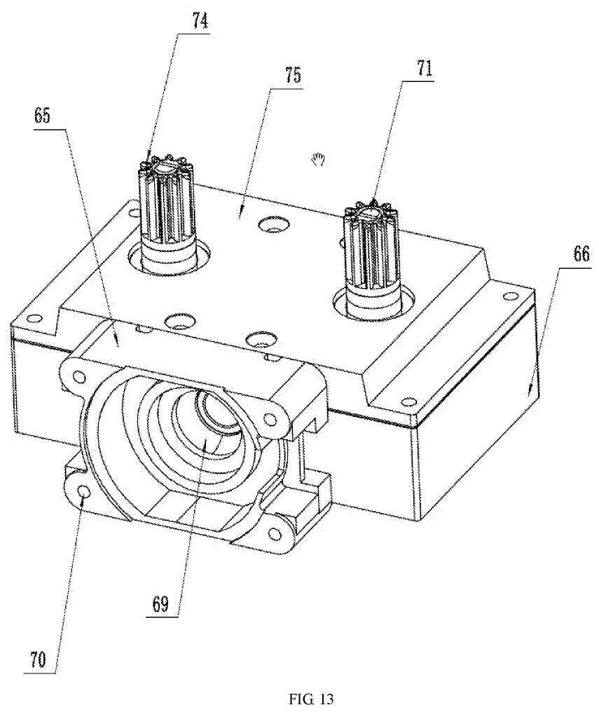

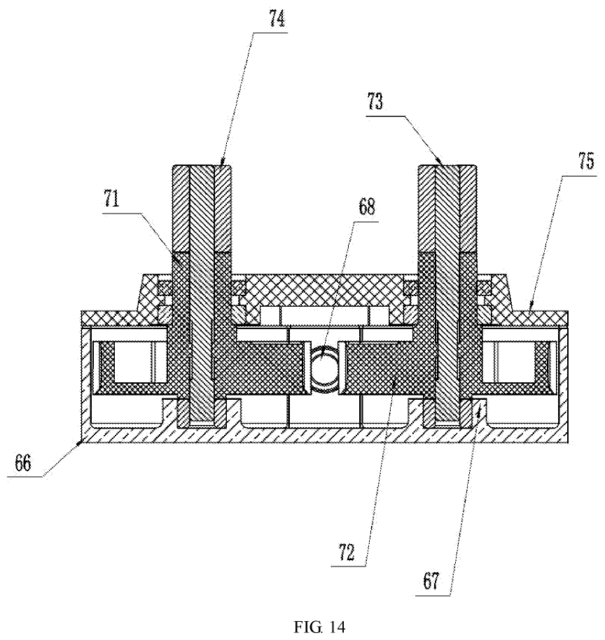

5) The assembly of a worm gearbox with coupled gears 65: as shown in FIG. 14, a tailor-made turbine 72 and a tailor-made shaft 73 are connected by injection molding, and then a tailor-made spur gear 74 is sheathed on an upper section of a cylinder of the tailor-made shaft to form a turbine spur gear 71. A lower section of the cylinder of each of two turbine spur gears 71 is embedded in a copper sleeve of each of two circular holes 67 symmetrically arranged at opposite sides of a bottom of a lower body 66. As shown in FIGS. 13-14, a front worm head of the worm motor is inserted into a copper sleeve of a front inner center circular groove 68 of the lower body 66 from a rear center through hole 69 of the lower body 66. Worm tooth mesh with two tailor-made turbines, and a middle part of the worm is arranged in a copper sleeve of the rear center though hole 69 of the lower body 66. The worm motor is connected to four circular holes 70 of a rear outer boss of the lower body 66, and two bearings are mounted on a box cover 75, and spur gears 77 of the two turbine spur gears 71 on the lower body 66 are embedded the two bearings on the box cover 75 through the two circular holes to form a double output end. As shown in FIGS. 4-5, the worm gearbox with coupled gears 65 enters a center space above a rectangular opening 8 in a middle of a bottom of the base. The two spur gears 77 at the dual output ends are embedded in two circular holes at the center space of the base 2, and respectively mesh with the two spur racks 45 of the twin-linked upper slider and the two spur racks 45 of the first lower slider and the second lower slider.

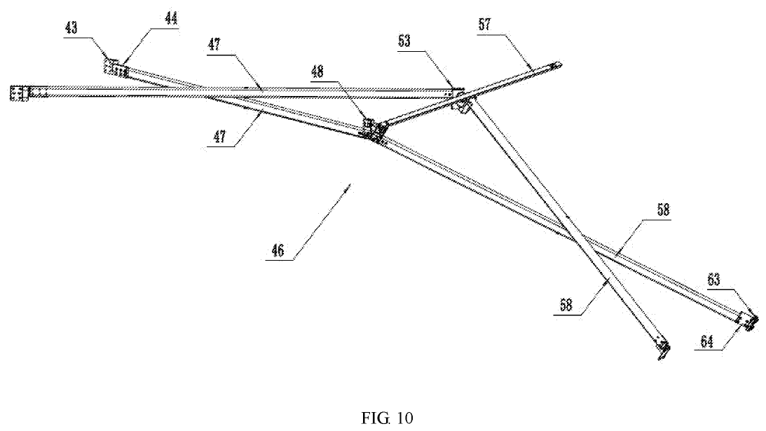

6) The assembly of the first and second brace rods 46: as shown in FIG. 10, there are two first brace rods and two second braces rods provided herein. First and second rear fixed hinges 43, first and second rear movable hinges 44, first and second rear brace rods 47, a first inclinable device 48, an intermediate sliding rod 57, a second inclinable device 53, first and second front brace rods 58, first and second front movable hinges 64, first and second front fixed hinges 63 and four bearings are provided on the first and second brace rods 46, respectively. The first front brace rod is below the second front brace rod, and the first rear brace rod is below the second rear brace rod. The first front fixed hinge and the first front movable hinge are arranged on the first front brace rod. The second front fixed hinge and the second front movable hinge are arranged on the second front brace rod. The first rear fixed hinge and the first rear movable hinge are arranged on the first rear brace rod. The second rear fixed hinge and the second rear movable hinge are arranged on the second rear brace rod. The first and second rear brace rods 47 each are provided with a through hole in a middle section and have flat surfaces at opposite sides. Rear ends of the flat surfaces each are provided with six screw holes to connect to the first and second rear movable hinges 44. The first and second rear movable hinges 44 are respectively connected to the first and second rear fixed hinges 43. Front ends of the flat surfaces each are provided with two circular holes. The first and second rear brace rods 47 are connected by stainless steel hollow rivets.

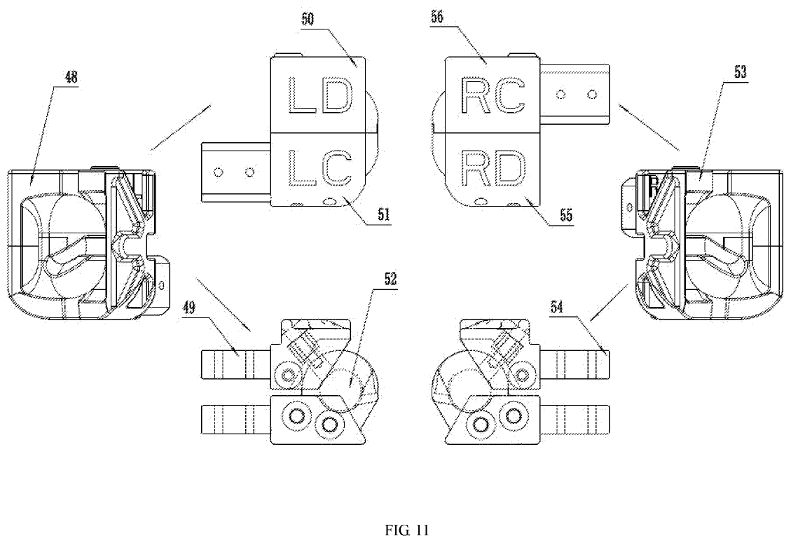

As shown in FIG. 11, the first inclinable device 48 includes a first hinge joint 49, a first short ball joint 50, a first long ball joint 51 and a cylindrical ball head 52 made of stainless steel. The first short ball joint 50 is arranged above the first long joint 51 to form a slide and a spherical space. A rear portion of the slide has upper and lower planes, and a front portion of the slide can be inclined by a downward rotation. A rear end of the cylindrical ball head 52 is embedded in a central concave through hole on an inner side of a rear section of the first hinge joint 49. A cylinder at a middle and the ball head at a front section of the cylindrical ball head 52 respectively enter the slide and the spherical space, thereby forming the first inclinable device 48.

Similarly, as shown in FIG. 11, the second inclinable device 53 includes a second hinge joint 54, a second short ball joint 55, a second long ball joint 56 and a cylindrical ball head 52 made of stainless steel. A rear end of the cylindrical ball head 52 is embedded in a central concave through hole on an inner side of a rear section of the second hinge joint 53. The second short ball joint 55 is arranged below the second long ball joint 56 to form a slide and a spherical space. A rear portion of the slide has upper and lower planes, and a front portion of the slide can be inclined by a downward rotation. A cylinder at a middle and the ball head at a front section of the cylindrical ball head 52 respectively enter the slide and the spherical space, thereby forming the second inclinable device 53.

As shown in FIG. 10, the first and second front brace rods 58 each have a through hole vertically arranged in a middle section and have flat surfaces at opposite sides. The flat surfaces each are provided with two circular holes at a rear end and four screw holes at a front end. The four screw holes are connected to each of the first and second front movable hinges 64. The first and second front movable hinges 64 are respectively connected to the first and second front fixed hinges 63. The first front fixed hinge of the first front brace rod is connected to four bearings, on which two fourth bearing raceways are arranged up and down. The first and second front brace rods 58 are connected by stainless steel hollow rivets. As shown in FIG. 10, the first inclinable device 48 is connected to a front end of the first rear brace rod and a rear end of the first front brace rod. The second inclinable device 53 is connected to a front end of the second rear brace rod and a rear end of the second front brace rod. The intermediate sliding rod 57 is arranged between two center screw holes of two circular bosses respectively located at a top of the first hinge joint 49 and a top of second hinge joint 54, thereby forming the first and second brace rods 46.

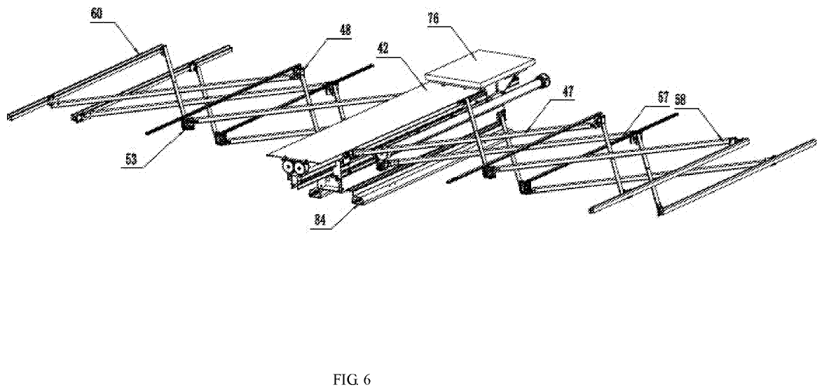

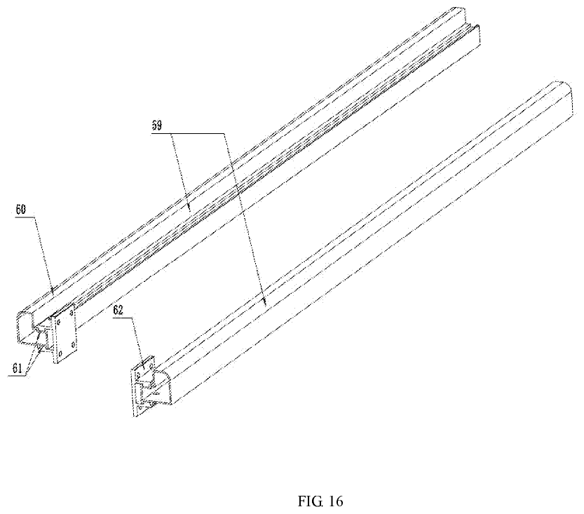

7) The assembly of the first and second crossbars 59: there are two first crossbars and two second crossbars provided herein. A beam 60 and a third fixed support 62 are provided in the first and second crossbars, respectively (as shown in FIG. 16). The beam 60 is an irregular extruded profile. Upper and lower concave slides 61 are arranged in an inner side of the beam 60. Upper and lower boss at an outside of the third fixed support 62 are embedded in rear ends of the upper and lower concave slides 61. Four screw holes are provided in an inner plane of the third fixed support 62 and connected to the second front fixed hinge of the second front brace rod (as shown in FIG. 6). Front portions of the upper and lower concave slides 61 are respectively inserted in the two fourth bearing raceways of the first front brace rod (as shown in FIG. 6). Outsides of the first and second crossbars 59 each are connected to the ray-proof shade cloth 29 by double-sided tapes and/or pulling rivets (as shown in FIG. 1, the double-sided tapes and the pulling rivets are preferably used herein in combination).

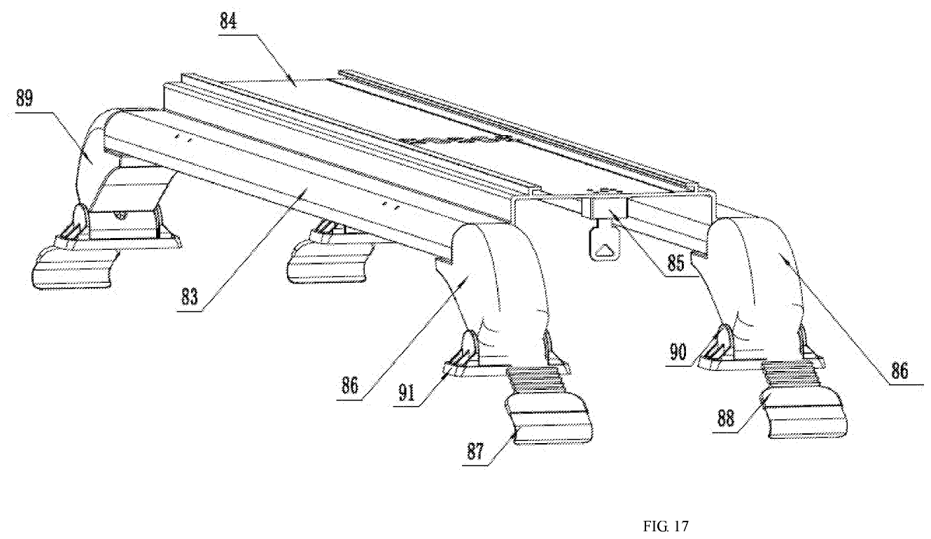

8) The assembly of the seat 83 and the shade-shed leg 86 (as shown in FIG. 17), where the seat 83 includes a shade-shed base 84, an anti-theft lock 85 and four Velcro tapes with barbed surfaces. The shade-shed base 84 is an irregular extruded profile. Two inward facing concave rails are symmetrically and longitudinally arranged on an upper portion of the shade-shed base 84. Two quad-side-encircled channels are separated and symmetrically and longitudinally arranged on a lower portion of the shade-shed base 84, thereby forming a longitudinal channel between the two quad-side-encircled channels. A longitudinal boss with a flat surface is arranged at a top-center of the longitudinal channel at a bottom of the shade-shed base 84. A rear end of the longitudinal boss is provided with four screw holes and a central circular hole, which are connected to the anti-theft lock 85. Front sections of the two quad-side-encircled channels are connected to two Velcro types on opposite outsides, and rear sections of the two quad-side-encircled channels are also connected to two Velcro tapes on opposite outsides, thereby forming the seat 83 (as shown in FIG. 17).

Four shade-shed legs 86 are respectively connected to four ports of the two quad-side-encircled channels located at a lower portion of the seat 83. Each shade-shed leg 86 includes a metal fixture, a fixing bracket, a fixing pin, a locking block, locking hardware, a locking injection molded part, an upper clock-plate, a lower lock-plate, a stainless steel tensioning bar, a hook plate 87 used for clamping and made of metal combined with soft rubber on an inner side, a leather sleeve 88, a fixed lock, an injection molded shield 89, a leg base 90 and a cushion 91 below the leg base. Four metal fixtures are connected to the two front ports and the two rear ports of the two quad-side-encircled channels by pulling rivets. Each metal fixture is connected to the fixing bracket, the fixing pin, the locking block and the locking hardware, respectively, where the locking hardware is connected to the locking injection molded part and the fixed lock, respectively, and the fixing pin is connected to the upper lock-plate and the lower lock-plate, then the injection molded shield 89 is configured to cover the above metal parts (as shown in FIG. 17).

A rear end of the stainless steel tensioning bar is connected to the hook plate 87, with the leather sleeve 88 sleeved at the junction. An upper end of the leg base 90 is connected to the metal fixture, and a lower end of the leg base 90 is connected to the cushion 91. Four cushions 91 below four leg bases are respectively attached to four corresponding places on the car roof. A front end of the stainless steel tensioning bar is inserted into a gap between the upper and lower lock-plates on the shade-shed leg 86. A tensioning piece made up of the locking hardware and the locking injection molded part is configured to drag in the stainless steel tensioning bar. The hook plate 87 is configured to hook four corners of the car, and the fixed lock is clamped and locked, so that the seat 83 and the shade-shed leg 86 are firmly connected to the car without damaging the car (as shown in FIG. 2).

Then, the above components are assembled in sequence: the first and second first bearing raceways 3 of the base are respectively embedded the two first groove slides 14 symmetrically arranged on the opposite outsides of the upper portion of the twin-linked upper slider 11. The middle and lower portions of the twin-linked upper slider 11 are arranged in the first concave channel 6 in the middle of the top of the base. The micro switch contact block 17 at a rear section of the twin-linked upper slider 11 is connected to the starting micro switch 78 arranged on a rear section of the first concave channel 6 on the top of the base. The two second bearing raceways 4 of the base are respectively inserted the upper second groove slide and the upper third groove slide, and the two third bearing raceways 5 of the base are respectively inserted the lower second groove slide and the lower third groove slide, where the upper second groove slide and the lower second groove slide 32 are respectively arranged at the top and the bottom of the first lower slider 30, and the upper and lower third groove slides 33 are respectively arranged at the top and the bottom of the second lower slider 31, thereby combining the base 2, the twin-linked upper slider 11, the first lower slider 30 and the second lower slider 31 (as shown in FIG. 9).

The upper roller frame 18 and the upper roller bracket 19 are respectively arranged on the front rectangular plane 13 and the rear rectangular plane 12 of the top of the twin-linked upper slider 11, and are respectively connected to two first winding-unwinding mechanisms 21 and two second winding-unwinding mechanisms 22. Two roll cylinders 28 each are arranged between the first winding-unwinding mechanism 21 and the second winding-unwinding mechanism 22. Six screw holes on each side of the upper roller bracket 19 are connected to the second rear fixed hinge 43 of the second rear brace rod 47 of the second brace rod 46b by stainless steel pan head screws.

Six screw holes on each first fixed support 9 of the base 2 are fixedly connected to the first rear fixed hinge 43 of the first rear brace rod 47 by the stainless steel pan head screws. The third fixed support 62 is fixed connected to the second front fixed hinge 63 of the second front brace rod 58 via stainless steel pan head screws. Front portions of the upper and lower concave slides 61 of the first and second crossbars 59 each are inserted in the two fourth bearing raceways of the front fixed hinge 63 of the first front brace rod 58.

One end of the ray-proof shade cloth 29 is connected to the roll cylinder 28, and the ray-proof shade cloth 29 is wound on the roll cylinder, and the other end of the ray-proof shade cloth 29 is fixedly connected to the outer plane of the first crossbar or the second crossbar via double-sided tapes and pulling rivets. Two unfolded ray-proof shade cloths 29 on the two roll cylinders 28 of the twin-linked upper slider 11 form two surfaces of an upper layer of the car shade-shed (as shown in FIG. 1). The first and second sliding supports each are fixedly connected to the second rear fixed hinge 43 of the second rear brace rod 47 via stainless steel pan head screws.

The two second fixed supports 10 of the base 2 each are fixedly connected to the first rear fixed hinge 43 of the first rear brace rod 47 via the stainless steel pan head screws. The third fixed support 62 is fixedly connected to the second front fixed hinge 63 of the second front brace rod via stainless steel pan head screws. The front portions of the upper and lower concave slides 61 of the first and second crossbars 59 each are inserted in the two fourth bearing raceways of the front fixed hinge 63 of the first front brace rod 58.

One end of the ray-proof shade cloth 29 is connected to the roll cylinder 28, and the ray-proof shade cloth 29 is wound on the roll cylinder, and the other end of the ray-proof shade cloth 29 is fixedly connected to the outer plane of the first crossbar or the second crossbar via double-sided tapes and pulling rivets. Two unfolded ray-proof shade cloths 29 on the two roll cylinders 28 of the first lower slider 30 and the second lower slider 31 form two surfaces of a lower layer of the car shade-shed (as shown in FIG. 1). Top planes of the upper roller frame 18 and the upper roller bracket 19 are fixedly connected to the shade-shed wrapping and the shade-shed cover plate 42 via stainless steel countersunk screws.

The solar base handle cover 77 is arranged at opposite sides of a rear top of the base 2. Two rectangular cantilevers with right angles are symmetrically fixedly arranged at opposite sides of a middle section of the solar base handle cover 77 via stainless steel countersunk screws, and the two rectangular cantilevers with right angles protrude from the back to the front. An encircled-five-side boss is arranged at a lower portion of the solar base handle cover 77 and is fixedly inserted into a rear lower space of the base 2 via stainless steel pan head screws.

A top plane of the solar base handle cover 77 is fixedly connected to the solar panel 76 by stainless steel screws and anti-off nuts. The wire plug of the solar panel 76 passes a semi-circular groove arranged from the rear to the front on a top of the encircled-five-side boss and enters the rear lower space of the base to connect to the solar charging socket. The solar charging socket is connected to the rechargeable battery. The rechargeable battery is connected to the main switch of the shade-shed 81, the battery indicator 80, the socket for charging and discharging 82 and the remote control receiver. The remote control receiver is connected to the starting micro switch 78, the stop micro switch 79 and the worm motor.

The rechargeable battery and the remote control receiver are arranged in a front lower space of the base 2. A lower front port of the base 2 is connected to the electrical panel, on which the battery indicator 80, the main switch of the shade-shed 81 and the socket for charging and discharging 82 are arranged. The worm gearbox 65 passes the rectangular opening 8 of the base, and enters a center of a space above the rectangular opening and is fixed on the base 2 via stainless steel screws and anti-off nuts. The two spur gears 92 at dual output ends are inserted in the two circular holes at the center space of the base 2. One spur gear 92 meshes with one spur rack 45 of the twin-linked upper slider and a spur rack 45 of the first lower slider. The other spur gear 92 meshes with the other spur rack 45 of the twin-linked upper slider and a spur rack 45 of the second lower slider (as shown in FIG. 4).

As shown in FIG. 2, two convex rails 7 arranged at opposite sides of the bottom of the base are respectively inserted in the two inward facing concave rails at the top of the seat 83. The anti-theft lock 85 at a rear bottom of the seat 83 upward locks the base 2. The four ports of the two quad-side-encircled channels below the seat 63 are connected to the four metal fixtures on the four shade-shed legs 86. The four leg bases 90 and the four cushions 91 below the four shade-shed legs 86 are affixed to four sides of the car roof. The hook plates 87 on the four shade-shed legs 86 hook four corners of the car, and the fixed lock is locked, thereby firmly connecting the full-automatic car shade-shed 1 to the car without damaging the car.

In the case where the unfolded shade-shed is needed, the users hold the controller 93 and press an “open” button of the controller, the worm motor operates forward to make the twin-linked upper slider and the first and second lower sliders slide in an opposite direction. When the micro switch contact block 17 of the twin-linked upper slider 11 slides forward to touch the stop micro switch 79 at the front section of the base 2, the worm motor stops rotating, at this time, the full-automatic car shade-shed 1 is fully unfolded, and meanwhile the wire plug of the special vehicle-mounted fan is inserted upwards into the socket for charging and discharging 82 on the electrical panel, and the fan operates by pressing a switch to cool down the interior of the car. In the case where the shade-shed is not required, the users hold the controller and press a “close” button of the controller, the worm motor operates backward, the micro switch contact block 17 of the twin-linked upper slider 11 slides backward to touch the starting micro switch 78 at the rear section of the base 2, the worm motor stops rotating, at this time, the full-automatic car shade-shed 1 is completely folded like a packing case. The full-automatic car shade-shed 1 has an anti-theft function and the car driving is not affected with the full-automatic car shade-shed 1 firmly installed on the car roof (as shown in FIG. 2).

At this point, the full-automatic car shade-shed of the invention is completely assembled. The full-automatic car shade-shed installed on the car roof can be automatically unfolded and folded through the remote operation of the controller (as shown in FIG. 2). The folded shade-shed on the car roof can be removed only by opening the anti-theft lock 85 and pulling a horizontal handlebar at a rear port of the encircled-five-sides boss of the solar base handle cover 77 by hands, and the process only costs a few seconds, at this time, the full-automatic car shade-shed is prepared for the store.

What is claimed is:

1. A full-automatic car shade-shed, comprising:
a base;
an electric control device;
a shade-shed wrapping;
a seat;
a shade-shed leg; and
a linkage device;
wherein the linkage device is provided in a middle of a space below the base, and comprises a worm gearbox with coupled gears, a plurality of spur racks, a twin-linked upper slider, a symmetric lower slider mechanism, two first brace rods, two second brace rods, two first crossbars, two second crossbars and a plurality of winding-unwinding devices; wherein the two first brace rods and the two second brace rods each are parallelly rotatable and inclinable and have foldable frames, each first brace rod and each second brace rod are symmetrically arranged; each first crossbar and each second crossbar are symmetrically arranged;
the base comprises two first fixed supports which are symmetrically arranged at opposite sides of the base, two second fixed supports which are symmetrically arranged at opposite sides of the base, a plurality of bearings, the electrical control device, the twin-linked upper slider, the symmetric lower slider mechanism; two first bearing raceways which are symmetrically provided at opposite sides of a top of the base; two first groove slides are symmetrically provided at opposite outsides of an upper portion of the twin-linked upper slider; the two first bearing raceways are respectively inserted in the two first groove slides;
the symmetric lower slider mechanism comprises a first lower slider and a second lower slider arranged at opposite sides, a first sliding support and a second sliding support arranged at opposite sides, two lower roller frames at front and rear sides, two spur racks arranged at opposite sides and two winding-unwinding devices arranged at opposite sides;
the twin-linked upper slider comprises an upper roller bracket, an upper roller frame, the shade-shed wrapping, a micro switch contact block, two spur racks arranged at opposite sides and two winding-unwinding devices;
each winding-unwinding device comprises a first winding-unwinding mechanism at a front end of the winding-unwinding device, a second winding-unwinding mechanism at a rear end of the winding-unwinding device, a roll cylinder and a ray-proof shade cloth;
one of the two first brace rods is arranged between the twin-linked upper slider and one of the two second crossbars, and one of the two second brace rods is arranged between the twin-linked upper slider and one of the two first crossbars, thereby forming two surfaces of an upper layer of the car shade-shed, and the two surfaces of the upper layer are symmetrically arranged at front and rear sides of the car shade-shed; the other second brace rod is arranged between the first lower slider and the other first crossbar, and the other first brace rod is arranged between the second lower slider and the other second crossbar, thereby forming two surfaces of a lower layer of the car shade-shed, and the two surfaces of the lower layer are symmetrically arranged at the front and rear sides of the car shade-shed; one end of the ray-proof shade cloth is wound on the roll cylinder, and the other end of the ray-proof shade cloth is connected to the first crossbar or the second crossbar;
four shade-shed legs are arranged at four corners below the seat and are configured to connect the car; two inward facing concave rails are provided at an upper portion of the car shade-shed, and two convex rails are provided at opposite sides of a bottom of the base; the two convex rails of the base are respectively inserted in the two inward facing concave rails;
the worm gearbox with coupled gears is arranged in the base, and first and second spur gears are symmetrically arranged at ends of two output ends of the worm gearbox; the first spur gear meshes with one of the two spur racks of the twin-linked upper slider and a spur rack of the first lower slider, and the second spur gear meshes with the other spur rack of the twin-linked upper slider and a spur rack of the second lower slider, forming a twist transmission by meshing the two sets of two spur racks and the first and second spur gears; two ray-proof shade cloths of the twin-linked upper slider and two ray-proof shade cloths of the symmetric lower slider mechanism stretch towards opposite sides to form four surfaces at the upper and lower layers of shade-shed, thereby presenting an unfolded state of the car shade-shed;
a first brace rod and a second brace rod are provided at each of two sides of the base; the first brace rod and the second brace rod each comprise first and second rear fixed hinges, first and second rear movable hinges, first and second rear brace rods respectively arranged up and down, a first inclinable device which is parallelly rotatable, a second inclinable device which is parallelly rotatable, an intermediate sliding rod, first and second front brace rods respectively arranged up and down, first and second front movable hinges, first and second front fixed hinges and a plurality of bearing; the first and second rear brace rods have arc-shaped tops and bottoms, and are respectively provided with a through hole at a middle section, and are arranged crosswise; through holes of the first and second rear brace rods are connected via hollow rivets; the first and second rear brace rods have flat surfaces on two sides, and rear ends of the flat surfaces each are symmetrically provided with six third screw holes; the six third screw holes are connected to the first and second rear movable hinges arranged down and up, respectively, and the first and second rear movable hinges arranged up and down are respectively connected to the first and second rear fixed hinges arranged up and down; front ends of the flat surfaces each are symmetrically provided with two circular holes;
the first and second brace rods located at the same side are respectively arranged in the upper and lower layers; the upper and lower layers each are provided with first and second brace rods; for the upper layer of the car shade-shed, one end of the first rear brace rod is connected to a first fixed support of the base by the first rear fixed hinge, and one end of the second rear brace rod is connected to six second screw holes of an upper roller bracket of the twin-linked upper slider, and the other end of the first rear brace rod is connected to the first inclinable device, and the other end of the second rear brace rod is connected to the second inclinable device;
for each of the first and second brace rods at the lower layer of the car shade-shed, one end of the first rear brace rod is connected to each of the second fixed supports of the base, and one end of the second rear brace rod is connected to each of the first and second sliding supports of the symmetric lower slider mechanism, and the other end of the first rear brace rod is connected to the first inclinable device, and the other end of the second rear brace rod is connected to the second inclinable device;
the first inclinable device comprises a first hinge joint, a first short ball joint, a first long ball joint and a cylindrical ball head made of stainless steel; a circular boss is provided at a top of a rear section of the first hinge joint, and a screw hole is provided at a center of the boss; a circular arc groove is provided at an inside of the rear section of the first hinge joint, and a concave through hole which has two flat surfaces at two sides and two circular surfaces at upper and lower sides is provided at a center of the circular arc groove and connects a circular hole to communicate with an outside; a rear port of the cylindrical ball head is embedded in the concave through hole at a center of an inside of the first hinge joint; a rear section of the cylindrical ball head has two flat surfaces at opposite sides and two circular surfaces at upper and lower sides, which is similar to that of the concave through hole of the first hinge joint; the cylindrical ball head is provided with a screw hole at a center of a rear port, a cylinder at a middle section and a sphere at a front section;
a lower portion of a front section of the first hinge joint is provided with a rectangular boss with two flat surfaces at opposite sides and two circular surfaces at upper and lower sides; two circular holes are symmetrically provided on the flat surfaces; a top of the first short ball joint is provided with two circular holes communicated with a bottom surface; a first hemisphere that is concave upwards is provided beside the bottom surface; a flat surface is provided at a rear portion of the first hemisphere and a rail that is inclined downwards is provided at a front portion of the first hemisphere; a top surface of a rear section of the first long ball joint is provided with two circular holes communicated with a bottom, and a second hemisphere that is concave downwards is provided beside the top surface of the rear section of the first long ball joint; a flat surface is provided at a rear portion of the second hemisphere and a rail that is inclined downwards is provided at a front portion of the second hemisphere;
a lower portion of a front section of the first long ball joint is provided with a rectangular boss with two circular surfaces at upper and lower sides and two flat surfaces at opposite sides; two circular holes are symmetrically arranged on the flat surfaces of the rectangular boss of the first long ball joint;
the first short ball joint is provided above the first long ball joint to form a spherical space and a slide around the spherical space; a rear portion of the slide has upper and lower planes and a front portion of the slide is rotational and inclined downwards; the sphere at the front section of the cylindrical ball head and the cylinder at the middle section of the cylindrical ball head are arranged in the spherical space and the slide around the spherical space; the rear port of the cylindrical ball head is connected to the first hinge joint via stainless steel screws; the cylinder at the middle section of the cylindrical ball and the sphere at the front section of the cylindrical ball are connected to the first short ball joint and the first long ball joint;
the second inclinable device has the same components as the first inclinable device; the second short ball joint is provided below the second long ball joint to form a spherical space and a slide around the spherical space; a rear portion of the slide has upper and lower planes and a front portion of the slide is rotational and inclined downwards; the sphere at the front section of the cylindrical ball head and the cylinder at the middle section of the cylindrical ball head are arranged in the spherical space and the slide around the spherical space; the rear port of the cylindrical ball head is connected to the second hinge joint via stainless steel screws; the cylinder at the middle section of the cylindrical ball and the sphere at the front section of the cylindrical ball are connected to the second short ball joint and the second long ball joint; the circular bosses at tops of the first and second inclinable devices each are connected to the intermediate sliding rod;
the first and second front brace rods have arc-shaped tops and bottoms, and two through holes which are concentric are respectively provided on the first and second front brace rods, and each through hole is between a top and a bottom; the first and second front brace rods are arranged crosswise and respectively located down and up; the two through holes are connected via hollow rivets; rear ends of the first and second front brace rods are respectively connected to the first inclinable device and the second inclinable device; the first and second front brace rods have flat surfaces on two sides, and rear ends of the flat surfaces each are symmetrically provided with two circular holes; the front ends of the flat surfaces each are symmetrically provided with four screw holes which are connected to the first and second front movable hinges, respectively; the first and second front movable hinges arranged down and up are respectively connected to the first and second front fixed hinges arranged down and up; the first front fixed hinge arranged down is connected to four bearings, and two fourth bearing raceways are formed on the four bearings; each fourth bearing raceway is slidably connected to the first and second crossbars, respectively.

2. The full-automatic car shade-shed of claim 1, wherein the base is made of extruded profiles; first bearing raceways are symmetrically arranged at opposite sides of the top of the base; a first concave channel is provided at a middle of the top of the base; second bearing raceways are symmetrically arranged at opposite outsides of an upper portion of the base; third bearing raceways are symmetrically arranged at opposite outsides of a middle portion of the base; a shoulder screw with slotted raised head, a rolling bearing, a washer and the base are connected to form a raceway unit, and a plurality of raceway units connected to the base are uniformly arranged in a longitudinal line, thereby forming the first bearing raceways, the second bearing raceways and the third bearing raceways which are arranged in a longitudinal direction; upper and lower second groove slides are respectively arranged at a top and a bottom of the first lower slider, and upper and lower third groove slides are respectively arranged at a top and a bottom of the second lower slider;
middle and lower portions of the twin-linked upper slider are arranged in the first concave channel at the middle of the top of the base; one second bearing raceway and one third bearing raceway are respectively inserted the upper and lower second groove slides; the other second bearing raceway and the other third bearing raceway are respectively inserted the upper and lower third groove slides;
the electrical control device comprises a solar panel, a solar base handle cover, a rechargeable battery, a solar charging socket, a remote control receiver, a remote controller, a starting micro switch, a stop micro switch, an electrical panel and a special vehicle-mounted fan; the electric panel is provided with a battery indicator, a main switch of the shade-shed and a socket for charging and discharging; the special vehicle-mounted fan comprises an electric fan, a fan base, a base cushion, a metal hose, a sucker, a switch and a wire plug;
the first fixed supports are symmetrically provided at opposite sides of a front top of the base, respectively; the second fixed supports are symmetrically provided at opposite outsides of a rear lower portion of the base; the starting micro switch and the stop micro switch are respectively arranged at a front section and a rear section of the first concave channel at the middle of the top of the base; a space is provided at an inside of a lower portion of the base, and the rechargeable battery and the remote control receiver are arranged at a front portion of the space; inside trapezoidal channels are symmetrically arranged at opposite insides of the first concave channel, respectively, and outer trapezoidal channels are symmetrically arranged at opposite outsides of the first concave channel, respectively; the four trapezoidal channels are symmetrically arranged; the electrical panel is connected to a port of the front portion of the space at the lower portion of the base; the solar base handle cover is connected to a port of a rear top of the base; a middle of a rear section of the bottom of the base is provided with four circular holes vertically spaced; a middle section of the bottom of the base is provided with a rectangular opening which is communicated with the space at the lower portion of the base; a middle top of the space at the lower portion of the base is provided with two circular holes symmetrically arranged; the worm gearbox passes the rectangular opening to enter the space of the base and then the worm gearbox is arranged near a center of the space of the base; the first and second spur gears symmetrically arranged at the two output ends of opposite sides of the worm gearbox are rotatably embedded in the two circular holes symmetrically arranged at the middle top of the space of the base.

3. The full-automatic car shade-shed of claim 1, wherein a top of the twin-linked upper slider is a rectangular plane; concave channels with right angles are arranged at opposite sides of the top of the twin-linked upper slider; two rectangular convex planes with right angles are symmetrically provided at opposite insides below the top of the twin-linked upper slider; the first groove slides are symmetrically arranged at opposite outsides of the upper portion of the twin-linked upper slider; first dovetail rails are symmetrically arranged at opposite outsides of a lower portion of the twin-linked upper slider, and are inserted with two spur racks; a second concave channel is provided at a bottom of the twin-linked upper slider; a micro switch contact block is provided at a top of a rear section of the second concave channel, and is connected to the starting micro switch on a rear section of the base; the first groove slides are respectively inserted inside the first bearing raceways; the two spur racks of the twin-linked upper slider sliding fit with the inside trapezoidal channels, respectively; the two spur racks of the twin-linked upper slider respectively intersect the two circular holes symmetrically arranged at a middle of the base; the upper roller frame is arranged at a front end of a top of the twin-linked upper slider; the upper roller frame has a flat top, and two circular holes symmetrically arranged and six first screw holes are provided on the flat top of the upper roller frame; an upper portion of the upper roller frame is provided with two circles that are twin-linked; a lower portion of the upper roller frame is provided with two blocks, and the two blocks are connected to bottoms of the two circles and are respectively provided with two protrusions with right angles; two countersink circular holes are provided at a center of a bottom of the two circles and communicated with the two blocks; the upper roller bracket is provided at a rear end of the top of the twin-linked upper slider; tops of the upper roller bracket and the upper roller frame have the same structure; six second screw holes are provided at each of opposite outsides of the upper roller bracket; lower portions and bottoms of the upper roller bracket and the upper roller frame have the same structure; the shade-shed wrapping comprises a cloth, a shade-shed cover plate, two elastic sheets, two wool tops, four nylon Velcro tapes with rough surfaces and a nylon Velcro tape with a barbed surface; two winding-unwinding devices are arranged between the upper roller bracket and the upper roller frame; each winding-unwinding device comprises the first winding-unwinding mechanism and the second winding-unwinding mechanism; the roll cylinder is arranged between the first and second winding-unwinding mechanisms; the ray-proof shade cloth is wound on the roll cylinder; the shade-shed cover plate of the shade-shed wrapping is arranged above top surfaces of the upper roller bracket and the upper roller frame.

4. The full-automatic car shade-shed of claim 2, wherein the first lower slider and the second lower slider are made of extruded profiles; a first arc channel is provided at an outside of the first lower slider near the roll cylinder, and a first convex track is provided on the first arc channel; two lower roller frames are respectively connected to front and rear ends of the first arc channel, and respectively provided with first and second winding-unwinding mechanisms; a roll cylinder is arranged between the first and second winding-unwinding mechanisms, and the ray-proof shade cloth is wound on the roll cylinder; a second dovetail rail is provided at an outside of the first lower slider away from the roll cylinder, and a spur rack is inserted in the second dovetail rail; a first concave rail is provided at a side of the bottom of the first lower slider near the roll cylinder; a second convex track is provided at a top of the first sliding support; the first sliding support is inserted in a rear port of the first concave rail; the first lower slider and the second lower slider are same in the structure; the spur rack of the first lower slider sliding fits with one outer trapezoidal channel of the base and intersects one circular hole at the middle of the base; the spur rack of the second lower slider sliding fits with the other outer trapezoidal channel and intersects the other circular hole at the middle of the base.

5. The full-automatic car shade-shed of claim 1, wherein two first crossbars and two second crossbars are provided herein; the first crossbar and the second crossbar have the same structure and are arranged symmetrically; a beam and a third fixed support is provided on the first and second crossbars, respectively; the beam is made of extruded profiles, and an outside of the beam is flat; upper and lower concave rails are symmetrically arranged at an inner side of the beam; upper and lower convex rails are symmetrically arranged at an outside of the third fixed support; the upper and lower convex rails are respectively embedded in the upper and lower concave rails; an inner side of the third fixed support is provided with a plane, and two screw holes are provided on the plane to connect the second front hinge of the second front brace rod; the upper and lower concave rails are inserted in the two fourth bearing raceways; an outside of the beam is connected to the ray-proof shade cloth via double-sided tapes and pulling rivets.

6. The full-automatic car shade-shed of claim 1, wherein the first winding-unwinding mechanism comprises an adjusting baffle, a spring sleeve, a sleeve cover plate and a scrolling clockwork spring; a rear section of the adjusting baffle is a cylinder, and a middle section of the adjusting baffle is a slightly smaller cylinder, and a first groove is provided at a middle of the slightly smaller cylinder; a front section of the adjusting baffle is a round shaft connected with an opening mandrel; a rear section of the spring sleeve is a small roll, and a front section of the spring sleeve is a large roll; a second groove is provided at a middle of the large roll, and two cross openings and four small rectangular openings are provided on a circumference of the second groove; four semicircular grooves are provided at an inside of a front port of the spring sleeve; a rear section of the sleeve cover plate is circular, and a first round hole is provided at a center of a rear port of the sleeve cover plate; the four semicircular bosses and four small rectangular bosses are provided on a circumference of the circle at a rear section of the sleeve cover plate, and the four small rectangular bosses and the four semicircular bosses are staggered; a square body is provided at a front section of the sleeve cover plate, and a second round hole is provided at a center of a port of the square body, and the second round hole is communicated with the first round hole at the rear port of the sleeve cover plate; the adjusting baffle is connected to the spring sleeve; an inner end of the scrolling clockwork spring is connected to the opening mandrel at the front section of the adjusting baffle; an outer end of the scrolling clockwork spring is connected to the two cross openings of the spring sleeve; the sleeve cover plate connects to the adjusting baffle and the spring sleeve; the second winding-unwinding mechanism and the first winding-unwinding mechanism have the same structure; the roll cylinder is arranged between the square body at the front section of sleeve cover plate of the first winding-unwinding mechanism and the square body at the front section of sleeve cover plate of the second winding-unwinding mechanism; the roll cylinder is wrapped with the ray-proof shade cloth; the second winding-unwinding mechanism is provided with a back-scrolling clockwork spring.

7. The full-automatic car shade-shed of claim 2, wherein the first winding-unwinding mechanism comprises an adjusting baffle, a spring sleeve, a sleeve cover plate and a scrolling clockwork spring; a rear section of the adjusting baffle is a cylinder, and a middle section of the adjusting baffle is a slightly smaller cylinder, and a first groove is provided at a middle of the slightly smaller cylinder; a front section of the adjusting baffle is a round shaft connected with an opening mandrel; a rear section of the spring sleeve is a small roll, and a front section of the spring sleeve is a large roll; a second groove is provided at a middle of the large roll, and two cross openings and four small rectangular openings are provided on a circumference of the second groove; four semicircular grooves are provided at an inside of a front port of the spring sleeve; a rear section of the sleeve cover plate is circular, and a first round hole is provided at a center of a rear port of the sleeve cover plate; the four semicircular bosses and four small rectangular bosses are provided on a circumference of the circle at a rear section of the sleeve cover plate, and the four small rectangular bosses and the four semicircular bosses are staggered; a square body is provided at a front section of the sleeve cover plate, and a second round hole is provided at a center of a port of the square body, and the second round hole is communicated with the first round hole at the rear port of the sleeve cover plate; the adjusting baffle is connected to the spring sleeve; an inner end of the scrolling clockwork spring is connected to the opening mandrel at the front section of the adjusting baffle; an outer end of the scrolling clockwork spring is connected to the two cross openings of the spring sleeve; the sleeve cover plate connects to the adjusting baffle and the spring sleeve; the second winding-unwinding mechanism and the first winding-unwinding mechanism have the same structure; the roll cylinder is arranged between the square body at the front section of sleeve cover plate of the first winding-unwinding mechanism and the square body at the front section of sleeve cover plate of the second winding-unwinding mechanism; the roll cylinder is wrapped with the ray-proof shade cloth; the second winding-unwinding mechanism is provided with a back-scrolling clockwork spring.

8. The full-automatic car shade-shed of claim 3, wherein the first winding-unwinding mechanism comprises an adjusting baffle, a spring sleeve, a sleeve cover plate and a scrolling clockwork spring; a rear section of the adjusting baffle is a cylinder, and a middle section of the adjusting baffle is a slightly smaller cylinder, and a first groove is provided at a middle of the slightly smaller cylinder; a front section of the adjusting baffle is a round shaft connected with an opening mandrel; a rear section of the spring sleeve is a small roll, and a front section of the spring sleeve is a large roll; a second groove is provided at a middle of the large roll, and two cross openings and four small rectangular openings are provided on a circumference of the second groove; four semicircular grooves are provided at an inside of a front port of the spring sleeve; a rear section of the sleeve cover plate is circular, and a first round hole is provided at a center of a rear port of the sleeve cover plate; the four semicircular bosses and four small rectangular bosses are provided on a circumference of the circle at a rear section of the sleeve cover plate, and the four small rectangular bosses and the four semicircular bosses are staggered; a square body is provided at a front section of the sleeve cover plate, and a second round hole is provided at a center of a port of the square body, and the second round hole is communicated with the first round hole at the rear port of the sleeve cover plate; the adjusting baffle is connected to the spring sleeve; an inner end of the scrolling clockwork spring is connected to the opening mandrel at the front section of the adjusting baffle; an outer end of the scrolling clockwork spring is connected to the two cross openings of the spring sleeve; the sleeve cover plate connects to the adjusting baffle and the spring sleeve; the second winding-unwinding mechanism and the first winding-unwinding mechanism have the same structure; the roll cylinder is arranged between the square body at the front section of sleeve cover plate of the first winding-unwinding mechanism and the square body at the front section of sleeve cover plate of the second winding-unwinding mechanism; the roll cylinder is wrapped with the ray-proof shade cloth; the second winding-unwinding mechanism is provided with a back-scrolling clockwork spring.

9. The full-automatic car shade-shed of claim 4, wherein the first winding-unwinding mechanism comprises an adjusting baffle, a spring sleeve, a sleeve cover plate and a scrolling clockwork spring; a rear section of the adjusting baffle is a cylinder, and a middle section of the adjusting baffle is a slightly smaller cylinder, and a first groove is provided at a middle of the slightly smaller cylinder; a front section of the adjusting baffle is a round shaft connected with an opening mandrel; a rear section of the spring sleeve is a small roll, and a front section of the spring sleeve is a large roll; a second groove is provided at a middle of the large roll, and two cross openings and four small rectangular openings are provided on a circumference of the second groove; four semicircular grooves are provided at an inside of a front port of the spring sleeve; a rear section of the sleeve cover plate is circular, and a first round hole is provided at a center of a rear port of the sleeve cover plate; the four semicircular bosses and four small rectangular bosses are provided on a circumference of the circle at a rear section of the sleeve cover plate, and the four small rectangular bosses and the four semicircular bosses are staggered; a square body is provided at a front section of the sleeve cover plate, and a second round hole is provided at a center of a port of the square body, and the second round hole is communicated with the first round hole at the rear port of the sleeve cover plate; the adjusting baffle is connected to the spring sleeve; an inner end of the scrolling clockwork spring is connected to the opening mandrel at the front section of the adjusting baffle; an outer end of the scrolling clockwork spring is connected to the two cross openings of the spring sleeve; the sleeve cover plate connects to the adjusting baffle and the spring sleeve; the second winding-unwinding mechanism and the first winding-unwinding mechanism have the same structure; the roll cylinder is arranged between the square body at the front section of sleeve cover plate of the first winding-unwinding mechanism and the square body at the front section of sleeve cover plate of the second winding-unwinding mechanism; the roll cylinder is wrapped with the ray-proof shade cloth; the second winding-unwinding mechanism is provided with a back-scrolling clockwork spring.

10. The full-automatic car shade-shed of claim 5, wherein the first winding-unwinding mechanism comprises an adjusting baffle, a spring sleeve, a sleeve cover plate and a scrolling clockwork spring; a rear section of the adjusting baffle is a cylinder, and a middle section of the adjusting baffle is a slightly smaller cylinder, and a first groove is provided at a middle of the slightly smaller cylinder; a front section of the adjusting baffle is a round shaft connected with an opening mandrel; a rear section of the spring sleeve is a small roll, and a front section of the spring sleeve is a large roll; a second groove is provided at a middle of the large roll, and two cross openings and four small rectangular openings are provided on a circumference of the second groove; four semicircular grooves are provided at an inside of a front port of the spring sleeve; a rear section of the sleeve cover plate is circular, and a first round hole is provided at a center of a rear port of the sleeve cover plate; the four semicircular bosses and four small rectangular bosses are provided on a circumference of the circle at a rear section of the sleeve cover plate, and the four small rectangular bosses and the four semicircular bosses are staggered; a square body is provided at a front section of the sleeve cover plate, and a second round hole is provided at a center of a port of the square body, and the second round hole is communicated with the first round hole at the rear port of the sleeve cover plate; the adjusting baffle is connected to the spring sleeve; an inner end of the scrolling clockwork spring is connected to the opening mandrel at the front section of the adjusting baffle; an outer end of the scrolling clockwork spring is connected to the two cross openings of the spring sleeve; the sleeve cover plate connects to the adjusting baffle and the spring sleeve; the second winding-unwinding mechanism and the first winding-unwinding mechanism have the same structure; the roll cylinder is arranged between the square body at the front section of sleeve cover plate of the first winding-unwinding mechanism and the square body at the front section of sleeve cover plate of the second winding-unwinding mechanism; the roll cylinder is wrapped with the ray-proof shade cloth; the second winding-unwinding mechanism is provided with a back-scrolling clockwork spring.

11. The full-automatic car shade-shed of claim 1, wherein the seat comprises a shade-shed base, an anti-theft lock for locking the base and four nylon Velcro tapes with barbed surfaces; the shade-shed base is made of extruded profiles; two inward facing concave rails are symmetrically and longitudinally arranged at opposite sides of an upper portion of the shade-shed base; a longitudinal channel is formed between the two inward facing concave rails; opposite sides of a middle of the shade-shed base are flat; two quad-side-encircled channels are symmetrically arranged at opposite sides of a lower portion of the shade-shed base, and the two quad-side-encircled channels are separated and longitudinally arranged; the two quad-side-encircled channels have flat tops, and opposite sides of the two quad-side-encircled channels are arc surfaces which are connected to the flat tops; two longitudinal concave tracks are symmetrically arranged at opposite sides of bottoms of the two quad-side-encircled channels, and a space passage is formed in a middle of each of the two quad-side-encircled channels; a longitudinal concave channel is provided between the bottoms of the two quad-side-encircled channels; a longitudinal boss with a flat surface is arranged at a top-center of the longitudinal channel, and a rear end of the longitudinal boss is provided with four screw holes, and a center of the four screw holes is provided with a circular hole communicated with a top of the shade-shed base; two nylon Velcro tapes with barbed surfaces are arranged at opposite sides of a front section of the shade-shed base; two nylon Velcro tapes with barbed surfaces are arranged at opposite sides of a rear section of the shade-shed base; the four screw holes at the rear end of the longitudinal boss and the circular hole at the center of the four screw holes are connected to the anti-theft lock; the convex rails are provided at the opposite sides of the bottom of the base, and the convex rails are respectively inserted in the two inward facing concave rails;
four shade-shed legs are respectively connected to two front ports and two rear ports of the two quad-side-encircled channels at opposite sides of the seat; each of the four shade-shed legs is provided with a stainless steel tensioning bar and a leg base; the leg base is provided with a cushion, and four cushions are respectively attached to four places of the car roof; each stainless steel tensioning bar is connected to a hook plate which is made of metal combined with soft rubber on an inner side and is configured to hook four corners of the car; the hook plate is covered with a leather sleeve attached at four edges of the car.

12. The full-automatic car shade-shed of claim 1, wherein the worm gearbox with coupled gears comprises a lower body, a box cover, two bearings, four copper sleeves, two turbine spur gears and a worm motor; the lower body comprises encircled-four-walls and a lower body bottom connected to the encircled-four-walls; two first arc curved surfaces are symmetrically arranged at a bottom of the encircled-four-walls, and the two first arc curved surfaces are connected with each other and communicated at middle sections of the two first arc curved surfaces; the two first arc curved surfaces each are provided with a circular boss; a central circular hole is provided on the circular boss; two central circular holes are respectively inserted in two copper sleeves; each copper sleeve tightly fits with each central circular hole; four first round holes are provided at four corners of a top of the encircled-four-walls and are communicated with the bottom of the encircled-four-walls; a round groove is provided at a center of a front inside of the encircled-four-walls; the round groove is inserted in a front inside copper sleeve, and the round groove tightly fits with the front inside copper sleeve; a rear central round hole is provided at a center of a rear inside of the encircled-four-walls, and the rear central round hole is inserted in a rear inner copper sleeve, and the rear central round hole tightly fits with the rear inner copper sleeve; the front inside copper sleeve and the rear inner copper sleeve are concentric;
four second round holes are provided at four corners of a rear outer port of the lower body; a rear outer central round hole is provided at a center of the four second round holes, and the rear outer central round hole is communicated with the rear central round hole and is concentric to the rear central round hole; a worm head of the worm motor enters the front inside copper sleeve from the rear outer central round hole; a middle section of a worm is arranged in the rear inner copper sleeve; worm tooth on the worm is arranged at a center of the two first arc curved surfaces; the worm motor is connected to the four second round holes via stainless steel screws;
a bottom of the box cover is provided with two second arc curved surfaces which are connected to each other and communicated with each other and are symmetrically arranged; two arc bosses are respectively provided on the two second arc curved surfaces; two circular concave surfaces are arranged between the two arc bosses; two bearings are inserted in the two circular concave surfaces; a center of the two circular concave surfaces is provided with two circular holes which are symmetric and communicated with a top of the box cover; four third round holes are provided on four corners of the top of the box cover, and the four third round holes and the four second round holes are concentric and communicated; each turbine spur gear comprises two tailor-made shafts, a tailor-made turbine and two tailor-made spur gears; each tailor-made shaft is a long cylinder; a lower section of the tailor-made shaft is cylindrical, and a middle section of the tailor-made shaft has two circles of tooth marks; an upper section of the tailor-made shaft is provided with a semi-circular cylinder; an upper section of the tailor-made turbine is provided with a combination of large and small cylinders, and a lower section of the tailor-made turbine is provided with a turbine; a bottom of the turbine is provided with a small round boss; a round through hole is provided between a top center and a bottom center;
the two tailor-made spur gears are dual output ends; a lower section of each tailor-made spur gear is cylindrical, and an upper section of the tailor-made spur gear is provided with a spur gear; a top center of the spur gear is provided with a semicircular hole that is communicated with a bottom of the spur gear; the tailor-made spur gear is embedded in the semi-circular cylinder of the tailor-made shaft; the semi-circular cylinder tightly fits with the tailor-made spur gear; the two tailor-made shafts are respectively inserted in two copper sleeves in two central circular holes of the lower body; two turbines are symmetrically arranged at opposite sides and mesh with the worm tooth of the worm at a middle of the lower body; the two tailor-made spur gears are inserted in the two bearings on the box cover and protrude out of the top of the box cover through two round holes; the front inside copper sleeve and the rear inner copper sleeve are connected to the worm on the worm motor; two copper sleeves at a lower side of the lower body are connected to the two turbine spur gears; two turbine spur gears are connected to the box cover; the lower body and the box cover are connected via stainless steel screws; a rear port of the lower body is connected to the worm motor via stainless steel screws.

13. The full-automatic car shade-shed of claim 1, wherein the electrical control device comprises a solar panel, a solar base handle cover, a rechargeable battery, a solar charging socket, a remote control receiver, a remote controller, a starting micro switch, a stop micro switch, an electrical panel and a special vehicle-mounted fan; the electric panel is provided with a battery indicator, a main switch of the shade-shed and a socket for charging and discharging; four round holes are provided at four corners of on a top plane of the solar base handle cover; a round hole connected to a square hole is arranged a top of the solar base handle cover; a wire groove from the top to the bottom is arranged below the square hole and located at a front side of an upper portion of the solar base handle cover; two rectangular cantilevers with right angles are symmetrically arranged at opposite sides of a middle section of the solar base handle, and the two rectangular cantilevers with right angles protrude from the back to the front; an encircled-five-side boss is arranged at a lower portion of the solar base handle, and the encircled-five-side boss protrudes from the back to the front; a semi-circular groove from the back to the front is arranged on a top plane of the encircled-five-sides boss; a rear end of the semi-circular groove is connected to the wire groove; a horizontal handlebar is provided at a rear port of the encircled-five-sides boss; there are space at upper and lower peripheries of the horizontal handlebar; the shape of the encircled-five-side boss is similar to the shape of the lower space of the base; a top of the solar base handle cover is connected to the solar panel; the two cantilevers symmetrically arranged at a middle portion of the solar base handle cover is connected to opposite rear ends of the top of the base; the encircled-five-side boss is inserted into a lower rear space of the base; a wire plug on the solar panel enters the lower space of the base from top to bottom and along the round hole connected to the square hole and the wire groove to connect to the solar charging socket; the other end of the solar charging socket is connected to the rechargeable battery;
the rechargeable battery is first connected to the main switch of the shade-shed, and then connected to the battery indicator, the socket for charging and discharging, the remote control receiver; the remote control receiver is connected to the starting micro switch, the stop micro switch and the worm motor.
